(19) United States
(12) Patent Application Publication
(10) Pub. No.: US 2026/0304476 A1
(43) Pub. Date: Oct. 1, 2026

(54) MULTI-LINK PROTECTION FOR LOW LATENCY COMMUNICATIONS

(71) Applicant: KONINKLIJKE PHILIPS N.V., EINDHOVEN (NL)

(72) Inventors: Serhat Erkucuk, Reston, VA (US); Jeongki Kim, Reston, VA (US); Esmael Hejazi Dinan, Reston, VA (US); Leonardo Alisasis Lanante, Reston, VA (US)

(21) Appl. No.: 19/474,751

(22) PCT Filed: Apr. 8, 2024
(86) PCT No.: PCT/EP2024/059464

§ 371 Date: Oct. 13, 2025

Related U.S. Application Data
(60) Provisional application No. 63/458,695, filed on Apr. 12, 2023.

(51) Int. Cl. H04W 74/0816; H04W 28/02; H04W 76/20; H04W 84/12

(52) U.S. Cl. CPC H04W 74/0816; H04W 28/0236; H04W 76/20; H04W 84/12

(57) ABSTRACT

A wireless device with multi-link capability (a multi-link device or ‘MLD’) may attempt to send low-latency data over one link. The recipient device may find that that link is, for it, occupied by another transmission. There are provided methods, devices and systems. An exemplary method comprises transmitting, by a first wireless device to a second wireless device, via a first link, a first request frame requesting transmission of first data, via the first link, to the second wireless device, and based on the first wireless device not receiving a first response frame from the second wireless device within a time period from transmission of the first request frame and the first data comprising low latency traffic, transmitting, by the first wireless device to the second wireless device, via a second link, a second request frame requesting transmission of the first data, via the second link, to the second wireless device.

### FIELD

The present invention relates to wireless networks, particularly but not limited to local area wireless networks using technologies such as the IEEE 802.11 standard.

### BACKGROUND

Modern wireless networks are often densely deployed. Devices face a lot of competition for medium access. When there are requirements on the time taken to send data (‘urgent data’ or so-called ‘low latency data’), the problem of competition for medium access becomes more acute.

### SUMMARY

The inventors have realized that a number of issues arise when multi-link operation (MLO) is being used. A wireless device with multi-link capability (a multi-link device or ‘MLD’) may attempt to send low-latency data over one link. It starts by asking the intended recipient device (the second device) whether that is possible. The second device may find that that link is, for it, occupied by another transmission (from another, overlapping, network—known as an overlapping basic service set or OBSS in the case of 802.11—for example). In this case, the second device does not acknowledge the request from the first device, forcing the first device to wait and then resend its request, causing time to be lost. Alternatively, a device may transmit data (which might not be low-latency data) over multiple links, blocking another device (such as one in an OBSS) from transmitting what may be low-latency data.

In an attempt to improve the functioning of wireless networks, there is provided methods, devices, systems and computer program products as defined in the appended claims.

In an aspect, there is provided a method, comprising transmitting, by a first wireless device to a second wireless device, via a first link, a first request frame requesting transmission of first data, via the first link, to the second wireless device; and based on the first wireless device not receiving a first response frame from the second wireless device within a time period from transmission of the first request frame and the first data comprising low latency traffic, transmitting, by the first wireless device to the second wireless device, via a second link, a second request frame requesting transmission of the first data, via the second link, to the second wireless device.

In an aspect, there is provided a method, comprising transmitting, by a first wireless device to a second wireless device, via a first link, a first request frame requesting transmission of first data, via the first link, to the second wireless device; and based on the first wireless device not receiving a first response frame from the second wireless device within a time period from transmission of the first request frame and the first data comprising low latency traffic, transmitting, by the first wireless device to the second wireless device, via a second link, a second request frame requesting transmission of the first data, via the second link, to the second wireless device.

In an embodiment, the method comprises receiving, by the first wireless device from the second wireless device, via the second link, a second response frame in response to the second request frame; and transmitting, by the first wireless device to the second wireless device, the first data, via the second link.

In an embodiment, the method comprises receiving, by the first wireless device from the second wireless device, via the second link, a second response frame in response to the second request frame.

In an embodiment, the method comprises transmitting, by the first wireless device to the second wireless device, via the first link, a third request frame requesting transmission of the first data, via the first link, to the second wireless device.

In an embodiment, the second and third request frames comprise MU-RTS trigger frames.

In an aspect, there is provided a method comprising receiving, by a first wireless device, data for transmission to a second wireless device, based on the data comprising low latency traffic, transmitting by the first wireless device to the second wireless device a first multi-user request-to-send (MU-RTS) trigger frame, via a first link, requesting transmission of the data, via the first link, to the second wireless device, and a second MU-RTS trigger frame, via a second link, requesting transmission of the data, via the second link, to the second wireless device.

In an aspect, there is provided a method comprising receiving, by a first wireless device (wireless device) from a second wireless device a first multi-user request-to-send (MU-RTS) trigger frame, via a first link, requesting transmission of data, via the first link, to the first wireless device, and a second MU-RTS trigger frame, via a second link, requesting transmission of the data, via the second link, to the first wireless device; and, based on the second MU-RTS trigger frame comprising an indication of the first link, discarding the first MU-RTS trigger frame; and transmitting, by the first wireless device to the second wireless device, a first response frame, via the second link, in response to the second MU-RTS trigger frame.

In an embodiment the request frame is a request-to-send (RTS) frame and the response frame is a clear-to-send (CTS) frame.

In an aspect, there is provided a device, when acting as a first wireless device (wireless device), arranged to perform operations comprising transmitting, to a second wireless device, via a first link, a first request frame requesting transmission of first data, via the first link, to the second wireless device; and based on not receiving a first response frame from the second wireless device within a time period from transmission of the first request frame and the first data comprising low latency traffic, transmitting to the second wireless device, via a second link, a second request frame requesting transmission of the first data, via the second link, to the second wireless device.

In an aspect, there is provided a device, when acting as a first wireless device, arranged to perform operations comprising transmitting to a second wireless device, via a first link, a first request frame requesting transmission of first data, via the first link, to the second wireless device; and based on not receiving a first response frame from the second wireless device within a time period from transmission of the first request frame and the first data comprising low latency traffic, transmitting to the second wireless device, via a second link, a second request frame requesting transmission of the first data, via the second link, to the second wireless device.

In an aspect, there is provided a device, when acting as a first wireless device, arranged to perform operations comprising receiving data for transmission to a second wireless device;
based on the data comprising low latency traffic, transmitting to the second wireless device a first multi-user request-to-send (MU-RTS) trigger frame, via a first link, requesting transmission of the data, via the first link, to the second wireless device, and a second MU-RTS trigger frame, via a second link, requesting transmission of the data, via the second link, to the second wireless device.

In an aspect, there is provided a device, when acting as a first wireless device, arranged to perform operations comprising receiving from a second wireless device a first multi-user request-to-send (MU-RTS) trigger frame, via a first link, requesting transmission of data, via the first link, to the device, and a second MU-RTS trigger frame, via a second link, requesting transmission of the data, via the second link, to the device; and, based on the second MU-RTS trigger frame comprising an indication of the first link, discarding the first MU-RTS trigger frame; and transmitting to the second wireless device, a first response frame, via the second link, in response to the second MU-RTS trigger frame.

In an embodiment, the wireless device is a station (STA) according to IEEE 802.11.

In an aspect, there is provided a wireless network comprising a plurality of devices as described herein.

In an aspect, there is provided a computer program product, stored on a computer-readable medium and arranged, when run a computing device, to perform the method described herein

The term ‘station’, when used herein, should be understood to apply to any wireless device and is not limited to a station according to 802.11, unless otherwise indicated.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example reference model for a multi-link device (MLD).

FIG. 8 illustrates an example of an AP MLD and an associated non-AP MLD.

FIG. 9 illustrates an example of a multi-link setup between an AP MLD and a non-AP MLD.

FIG. 10 illustrates an example of a traffic identifier (TID)-to-link mapping in a multi-link communication environment.

FIG. 11 illustrates an example of a Request-to-Send (RTS)/Clear-to-Send (CTS) procedure.

FIG. 12 illustrates an example of an existing procedure which may be used to transmit low latency data protected by an RTS/CTS exchange.

FIG. 13 illustrates another example of an existing procedure which may be used to transmit low latency data protected by an RTS/CTS exchange.

FIG. 14 illustrates another example of an existing procedure which may be used to transmit low latency data protected by an RTS/CTS exchange.

FIG. 15 illustrates an example process according to an embodiment.

FIG. 16 illustrates an example of a proposed procedure which may be used to transmit low latency data protected by an RTS/CTS exchange according to an embodiment.

FIG. 17 illustrates an example of a proposed procedure which may be used to transmit low latency data protected by an RTS/CTS exchange according to an embodiment.

FIG. 18 illustrates an example of a proposed procedure which may be used to transmit low latency data protected by an RTS/CTS exchange according to an embodiment.

FIG. 19 illustrates an example of a proposed procedure which may be used to transmit low latency data protected by an RTS/CTS exchange according to an embodiment.

FIG. 20 illustrates an example of a proposed procedure which may be used to transmit low latency data protected by an RTS/CTS exchange according to an embodiment.

FIG. 21 illustrates an example of a common info field of a basic multi-link element according to an embodiment.

FIG. 22 illustrates an example multi-user request-to-send (MU-RTS) trigger frame according to an embodiment.

FIG. 23 illustrates an example process according to an embodiment.

FIG. 24 illustrates another example process according to an embodiment.

FIG. 25 illustrates another example process according to an embodiment.

### DETAILED DESCRIPTION

In the present disclosure and Figures, same reference signs designate same elements.

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any Figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of,” as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on,” as used herein, may be interpreted as “based at least in part on” rather than, for example, “based solely on.” The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

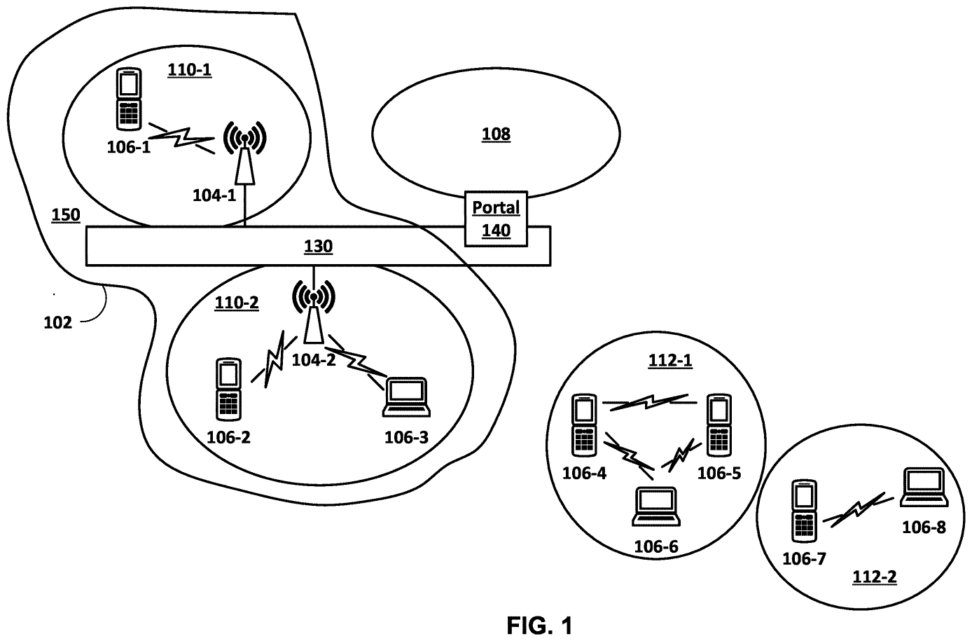

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

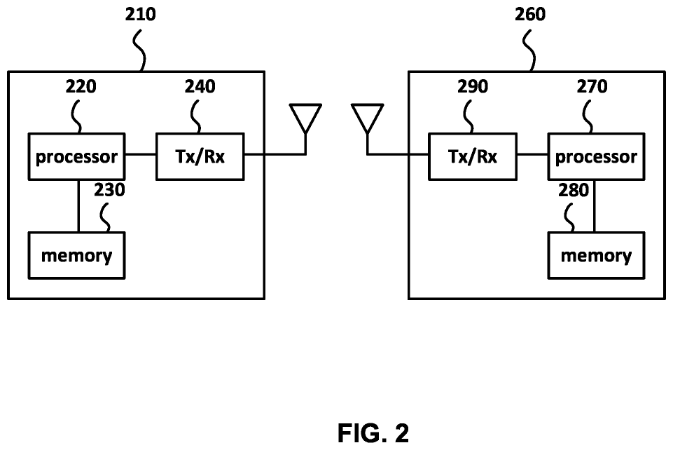

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

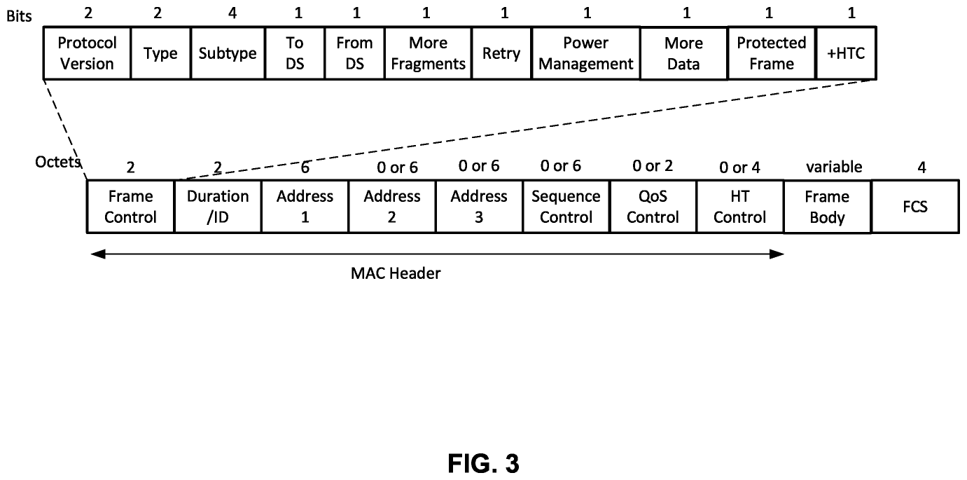

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS,” “From DS,” “More Fragments,” retry, power management, “More Data,” protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield, and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QOS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

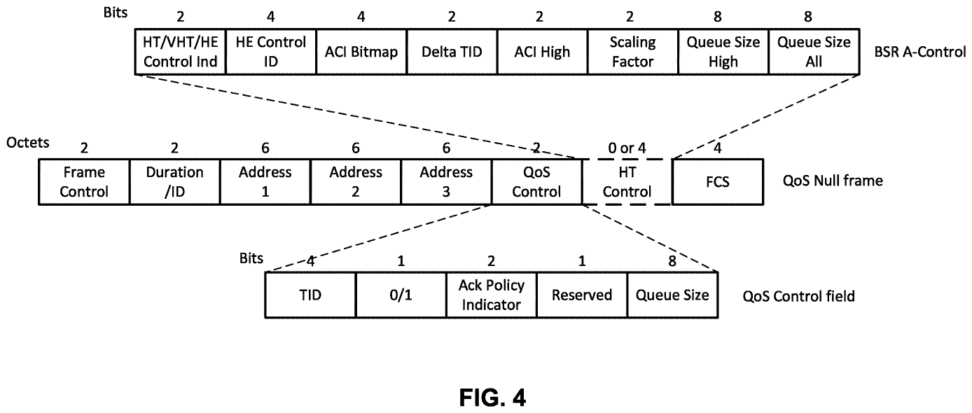

FIG. 4 illustrates an example of a QoS null frame indicating buffer status information. A QOS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:

The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.

A queue size value of 0 is used solely to indicate the absence of any buffered traffic in the queue used for the specified TID.

A queue size value of 254 is used for all sizes greater than 64 768 octets.

A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories (ACs) for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included. The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO. The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

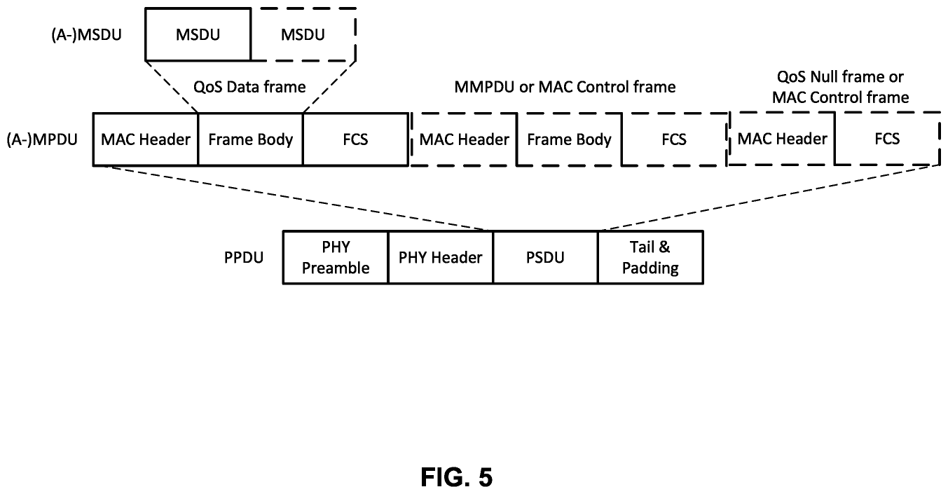

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

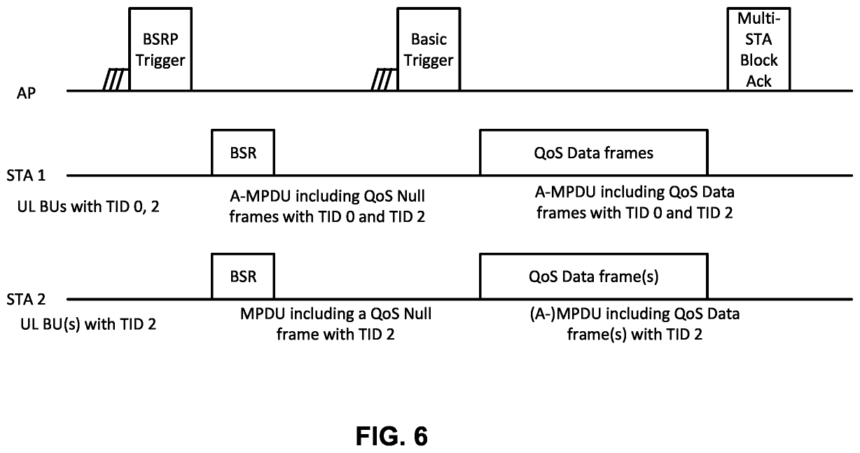

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g., TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield. On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID. The AP may acknowledge the transmitted TB PPDUs from STA 1 and STA 2 by sending a multi-STA block ack frame.

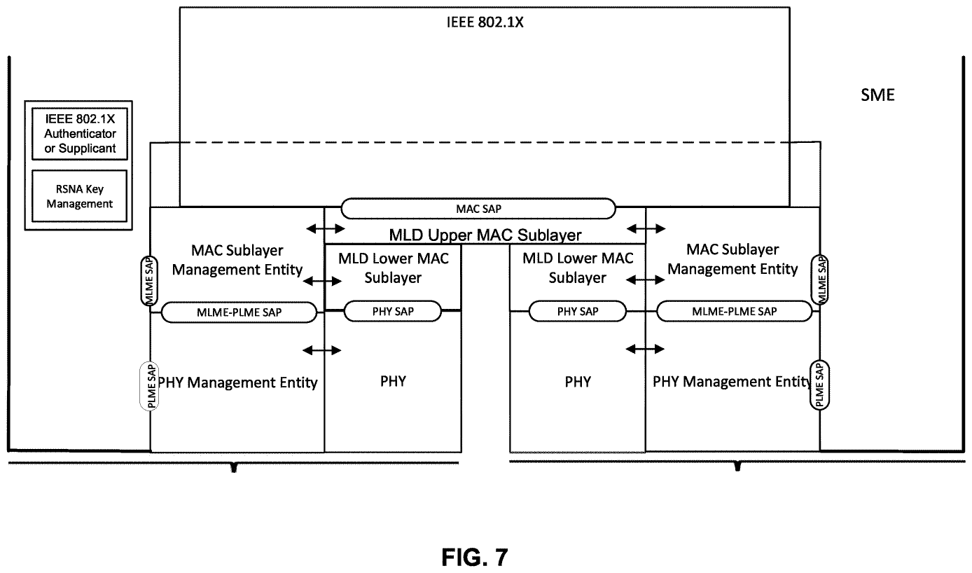

FIG. 7 illustrates an example reference model for a multi-link device (MLD).

An MLD is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both of the communicating AP MLD and non-AP MLD.

As shown in FIG. 7, a MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

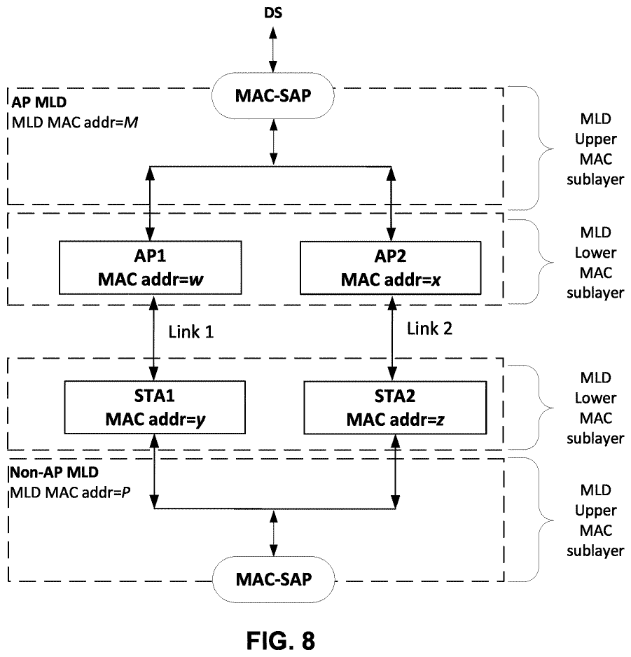

FIG. 8 illustrates an example of an AP MLD and an associated non-AP MLD.

As shown, the AP MLD has two affiliated APs (AP1 and AP2), and the non-AP MLD has two affiliated STAs (STA 1 and STA 2). The AP MLD and the non-AP MLD may be communicatively coupled by two links (Link 1 and Link 2.) Link 1 is established between AP1 and STA1, and link 2 is established between AP2 and STA2.

Generally, the MAC addresses of an MLD and of its affiliated STAs are different from one another. For example, as shown in FIG. 8, the AP MLD may have MAC address M, AP 1 may have MAC address w, and AP2 may have with MAC address x. Similarly, the non-AP MLD may have MAC address P, STA 1 may have MAC address y, and STA2 may have MAC address z.

As shown in FIG. 8, with each MLD, the MAC sublayer may be further divided into an MLD upper MAC sublayer and an MLD lower MAC sublayer. The MLD upper MAC sublayer (MLD) performs functionalities that are common across all links. The MLD lower MAC sublayer performs functionalities that are local to each link. Some of the functionalities require joint processing of both the MLD upper and the MLD lower MAC sublayers.

The MLD upper MAC sublayer functions may include:
Authentication, association, and reassociation (between an AP MLD and a non-AP MLD);
Security association (e.g., pairwise master key security association (PMKSA), pairwise transient key security association (PTKSA)) and distribution of group temporal key (GTK)/integrity GTK (IGTK)/beacon IGTK (BIGTK);
Sequence number (SN)/packet number (PN) assignment for frames to be encrypted by pairwise transient key (PTK) for unicast frames;
Encryption/decryption using PTK for unicast frames;
Selection of the MLD lower MAC sublayer for transmission (TID-to-link mapping);
Reordering of packets to ensure in-order delivery per each Block Ack session;
Block Ack scoreboarding for individually addressed frames (in collaboration with the MLD lower MAC sublayer); optionally, the MLD upper MAC sublayer delivers the Block Ack record on one link to the MLD lower MAC sublayer of other links; and
MLD level management information exchange/indication via the MLD lower MAC sublayer

The MLD lower MAC sublayer functions may include:
Maintenance of link specific GTK/IGTK/BIGTK (between an AP affiliated with the AP MLD and a STA affiliated with the non-AP MLD);
Link-specific encryption/decryption/integrity protection and PN assignment using GTK/IGTK/BIGTK (between an AP affiliated with the AP MLD and a STA affiliated with the non-AP MLD);
Link specific management information exchange/indication (e.g., beacon);
Link specific control information exchange/indication (e.g., RTS/CTS, acknowledgements, etc.);
Power save state and mode;
MAC address filtering for frame reception; and
Block Ack scoreboarding for individually addressed frames (in collaboration with the MLD upper MAC sublayer); optionally, the MLD lower MAC sublayer receives the Block Ack record on the other links from the MLD upper MAC sublayer.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

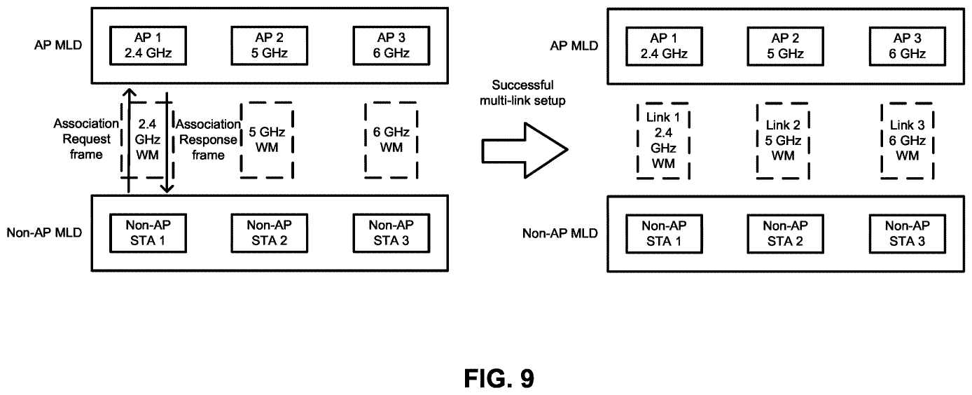

FIG. 9 illustrates an example of a multi-link setup between an AP MLD and a non-AP MLD. As shown, the AP MLD has three affiliated APs: AP 1 operating in the 2.4 GHz band, AP 2 operating in the 5 GHz band, and AP 3 operating in the 6 GHz band. The non-AP MLD has three affiliated STAs: non-AP STA 1 operating in the 2.4 GHz band, non-AP STA 2 operating in the 5 GHz band, and non-AP STA 3 operating in the 6 GHz band.

The non-AP MLD may initiate multi-link setup by non-AP STA 1 sending an association request frame to AP 1 affiliated with the AP MLD. In the association request frame, the transmitter address (TA) field is set to the MAC address of non-AP STA 1 and the receiver address (RA) field is set to the MAC address of AP 1. The association request frame includes a basic multi-link element that indicates the MLD MAC address of the non-AP MLD and complete information of non-AP STA 1, non-AP STA 2, and non-AP STA 3. The association request frame may request the setup of three links between the non-AP MLD and the AP MLD (a link between AP 1 and non-AP STA 1, a link between AP 2 and non-AP STA 2, and a link between AP 3 and non-AP STA 3).

The AP MLD may respond to the requested multi-link setup by AP sending an association response frame to non-AP STA 1 affiliated with the non-AP MLD. In the association response frame, the TA field is set to the MAC address of the AP 1 and the RA field is set to the MAC address of the non-AP STA 1. The association response frame includes a basic multi-link element that indicates the MLD MAC address of the AP MLD and complete information of AP 1, AP 2, and AP 3. The association response frame signals successful multi-link setup by the setup of three links between the non-AP MLD and AP MLD (link 1 between AP 1 and non-AP STA 1, link 2 between AP 2 and non-AP STA 2, and link 3 between AP 3 and non-AP STA 3).

By default, all TIDs at the non-AP MLD are mapped to all setup links for both uplink and downlink. The TID-to-link mapping mechanism allows an AP MLD and a non-AP MLD that performed or are performing multi-link setup to specify how UL and DL QoS traffic corresponding to different TIDs (e.g., between 0 and 7) may be assigned to the setup links. In a negotiated TID-to-link mapping, a TID may be mapped to a link set, which is a subset of setup links, ranging from a single setup link to all the setup links.

A setup link is defined as enabled for a non-AP MLD if at least one TID is mapped to that link either in DL or in UL, and is defined as disabled if no TIDs are mapped to that link both in DL and UL. At any point in time, a TID is always mapped to at least one setup link both in DL and UL, which means that a TID-to-link mapping change can only be valid and successful if it does not result in a TID having a mapped link set made of zero setup links.

By default, all setup links are enabled. If a link is enabled for a non-AP MLD, it may be used for the exchange of individually addressed frames, subject to the power state of the non-AP STA operating on that link. Only MSDUs or A-MSDUs with TIDs mapped to a link may be transmitted on that link in the direction (DL/UL) corresponding to the TID-to-link mapping. Individually addressed management frames and control frames may be sent on any enabled link between an affiliated STA of the non-AP MLD and a corresponding AP of the AP MLD, both in DL and UL.

If a link is disabled for a non-AP MLD, the link may not be used for the exchange of individually addressed frames between an affiliated STA of the non-AP MLD and a corresponding AP of the AP MLD.

If a TID is mapped in UL to a set of enabled links for a non-AP MLD, the non-AP MLD may use any link within this set of enabled links to transmit individually addressed MSDUs or A-MSDUs corresponding to that TID.

If a TID is mapped in DL to a set of enabled links for a non-AP MLD, the non-AP MLD may retrieve individually addressed BUs buffered at the AP MLD that are MSDUs or A-MSDUs corresponding to the TID, on any link of the set of enabled links. Conversely, the AP MLD may use any link within the set of enabled links to transmit individually addressed MSDUs or A-MSDUs corresponding to the TID, subject to the power state of the non-AP STA on each of the used links.

If the default mode is used, the non-AP MLD may retrieve BUs buffered by the AP MLD on any setup link, though the AP MLD may recommend a link.

A non-AP MLD may retrieve buffered BUs that are MMPDUs buffered at the AP MLD on any enabled link. An AP MLD may use any enabled link to transmit individually addressed bufferable management frames that are not measurement MMPDUs, subject to the power state of the non-AP STA on the used link.

If a STA affiliated with a non-AP MLD is in active mode on a link with a set of TIDs mapped for DL transmission, its associated AP affiliated with the AP MLD may transmit to the STA: MSDUs/A-MSDUs for the set of mapped TIDs for the non-AP MLD; and MMPDUs that are not measurement MMPDUs for the non-AP MLD or its affiliated STAs, unless the frames are transmitted to another STA affiliated with the same non-AP MLD and in active mode.

As mentioned above, under the default mapping mode, all TIDs are mapped to all setup links for DL and UL, and all setup links are enabled. A non-AP MLD and an AP MLD that perform multi-link setup shall operate under this mode if a TID-to-link mapping negotiation for a different mapping has not occurred, was unsuccessful, or was torn down.

In a multi-link (re)setup procedure, a non-AP MLD may initiate a TID-to-link mapping negotiation by including a TID-to-link mapping element in a (re)association request frame if an AP MLD has indicated support for TID-to-link mapping negotiation.

After receiving the (re)association request frame containing the TID-to-link mapping element, the AP MLD may reply to the (re)association request frame according to the following rules. The AP MLD can accept the requested TID-to-link mapping indicated in the TID-to-link mapping element in the received (re)association request frame only if it accepts the multi-link (re)setup for all links on which at least one TID is requested to be mapped. In this case, the non-AP MLD does include in the (re)association response frame a TID-to-link mapping element. Otherwise, the non-AP MLD indicates rejection of the proposed TID-to-link mapping by including in the (re)association response frame a TID-to-link mapping element that suggests a preferred TID-to-link mapping.

Following a successful multi-link (re)setup, to negotiate a new TID-to-link mapping, an initiating MLD may send an individually addressed TID-to-link mapping request frame to a responding MLD that has indicated support of TID-to-link mapping negotiation.

On receiving the individually addressed TID-to-link mapping request frame, the responding MLD sends an individually addressed TID-to-link mapping response frame to the initiating MLD according to the following rules. The responding MLD may accept the requested TID-to-link mapping indicated in the TID-to-link mapping element in the received TID-to-link mapping request frame by transmitting a TID-to-link mapping response frame. Otherwise, the responding MLD may indicate rejection of the proposed TID-to-link mapping in the TID-to-link mapping response frame. The responding MLD may suggest a preferred TID-to-link mapping in the TID-to-link mapping response frame by including the TID-to-link mapping element in the TID-to-link mapping response frame.

An MLD may suggest a preferred TID-to-link mapping to a peer MLD by sending an unsolicited TID-to-link mapping response frame that includes a TID-to-link mapping element.

When a peer MLD indicates a preferred TID-to-link mapping, an MLD may take into account the preferred TID-to-link mapping when it initiates a new TID-to-link mapping. In addition, an AP MLD may take into account the traffic flow(s) affiliated with the non-AP MLD and the capabilities and constraints (if any) of the non-AP MLD.

When two MLDs have negotiated a TID-to-link mapping, MLD may tear down the negotiated TID-to-link mapping by sending an individually addressed TID-to-link mapping teardown frame. After teardown, the MLDs operates in default mapping mode.

When an MLD successfully negotiates a TID-to-link mapping with a peer MLD, both the MLD and the peer MLD update an uplink and/or downlink TID-to-link mapping information according to the negotiated the TID-to-link mapping.

When an MLD has successfully negotiated with a peer MLD an uplink and/or downlink TID-to-link mapping in which the bit position i of a link mapping field n in the TID-to-link mapping element is set to 0, a TID n shall not be mapped to the link associated with the link ID i in uplink and/or downlink. When an MLD has successfully negotiated with a peer MLD an uplink and/or downlink TID-to-link mapping in which the bit position i of a link mapping field n in the TID-to-link mapping element is set to 1, the TID n is mapped to the link associated with the link ID i in uplink and/or downlink.

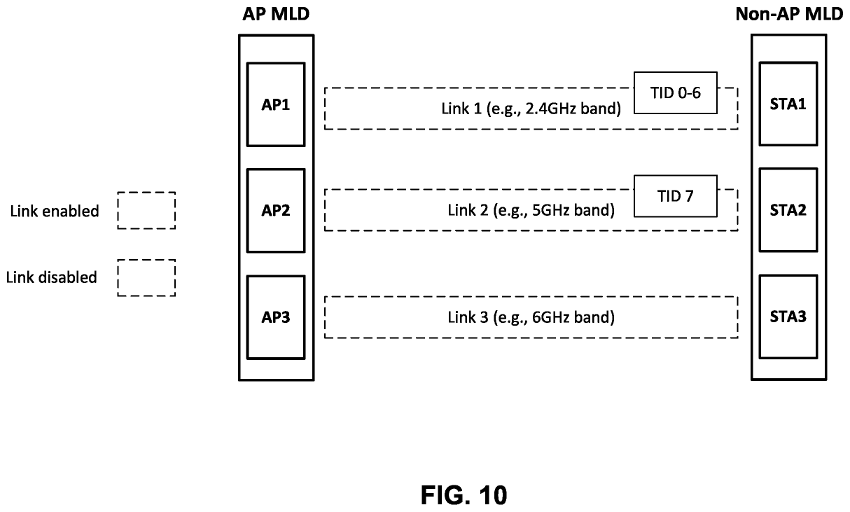

FIG. 10 illustrates an example of a TID-to-link mapping in a multi-link communication environment. As shown, the multi-link communication environment includes an AP MLD having three affiliated APs and a non-AP MLD having three affiliated STAs.

During or after multi-link setup, the non-AP MLD and the AP MLD may negotiate a TID-to-link mapping. The TID-to-link mapping maps TIDs at the non-AP MLD in UL and DL to setup links between the AP MLD and the non-AP MLD. For example, as shown in FIG. 10, the TID-to-link mapping may map TIDs 0-6 in both UL and DL to link 1 and TID 7 in both UL and DL to link 2. As such, links 1 and 2 are enabled, and link 3 is disabled. The TID-to-link mapping negotiation may be performed by exchanging an association request/response frame or a TID-to-link mapping request/response frame between the non-AP MLD and the AP MLD.

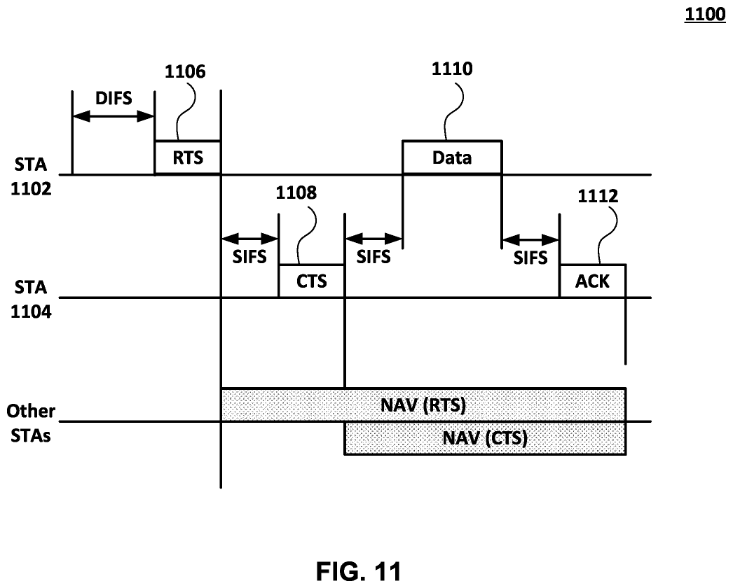

FIG. 11 illustrates an example 1100 of a Request-to-Send (RTS)/Clear-to-Send (CTS) procedure. Example RTS/CTS procedure 1100 may be an example according to the RTS/CTS procedure as defined in section 10.3.2.9 of the IEEE 802.11 standard draft “IEEE P802.11-REVme™/D2.1, January 2023.” As shown in FIG. 11, example RTS/CTS procedure 1100 may include STAs 1102 and 1104. Other STAs of the same BSS may also be within communication range of STAs 1102 and 1104.

In an example, STA 1102 may transmit an RTS frame 1106 to STA 1104. STA 1102 may transmit RTS frame 1106 to protect from hidden STA(s) the transmission of a data frame 1110 that STA 1102 intends to transmit. RTS frame 1106 may include a Duration/ID field. The Duration/ID field may be set to the time, in microseconds, required to transmit data frame 1110, plus one CTS frame, plus one ACK frame (if required), plus three SIFS (Short Interframe Spacing) periods.

In an example, STA 1104 may respond to RTS frame 1106 by transmitting a CTS frame 1108 to STA 1102. CTS frame 1108 may be transmitted one SIFS period after RTS frame 1106. STA 1104 may respond to RTS frame 1106 when RTS frame 1106 is addressed to STA 1104 and after considering the NAV, unless the NAV was set by a frame originating from STA 1102. STA 1104 may respond to the RTS frame 1106 when RTS frame 1106 is addressed to STA 1104 and if the NAV indicates idle. For a non-SIG STA, the NAV indicates idle when the NAV count is 0 or when the NAV count is non-zero but a nonbandwidth signaling TA obtained from a TA field of RTS frame 1106 matches a saved TXOP holder address. For an SIG STA, the NAV indicates idle when both the NAV and RID (response indication deferral) counters are 0 or when either the NAV or RID counter is non-zero but the TA field of RTS frame 1106 matches the saved TXOP holder address.

STA 1104 may set an RA field of CTS frame 1108 to a nonbandwidth signaling TA obtained from the TA field of RTS frame 1106. STA 1104 may set a Duration field of CTS frame 1108 based on the Duration/ID field of RTS frame 1106, namely as equal to the value of the Duration/ID field of RTS frame 1106, adjusted by subtracting the time required to transmit CTS frame 1108 and one SIFS period.

Upon receiving CTS frame 1108, STA 1102 may wait one SIFS period before transmitting data frame 1110. STA 1104 may transmit an ACK frame 1112 in response to data frame 1110. STA 1104 may transmit ACK frame 1112 one SIFS after receiving data frame 1110.

As shown in example 1100, other STAs within communication range of STAs 1102 and 1104, and belonging to the same BSS, may set their NAVs according to RTS frame 1106 and/or CTS frame 1108. For example, a STA receiving RTS frame 1106 may set its NAV based on the Duration/ID field of RTS frame 1106. Another STA receiving CTS frame 1008 may set its NAV based on the Duration field of CTS frame 1108. As such, the other STAs may not access the channel using EDCA until the end of transmission of ACK frame 1112. Similarly, STAs belonging to an overlapping BSS (OBSS) may set their NAVs according to RTS or CTS frames, if they are within the communication range of the transmitting STA.

It is anticipated that future IEEE 802.11 standards provide various mechanisms to support the quality of service (QoS) requirements of low latency (LL) (or latency sensitive) traffic. Such traffic may originate from various real time applications having stringent latency requirements (e.g., very low average latency, a worst-case latency of the order of a few to tens of milliseconds, and/or a small jitter). In operation, LL traffic may be associated with one or more traffic identifiers (TIDs) associated with one or more predetermined ACs or traffic streams (hereinafter TIDs associated with LL traffic are called LL TIDs). The one or more predetermined ACs may comprise the access categories for video (AC_VI) and voice (AC_VO), for example.

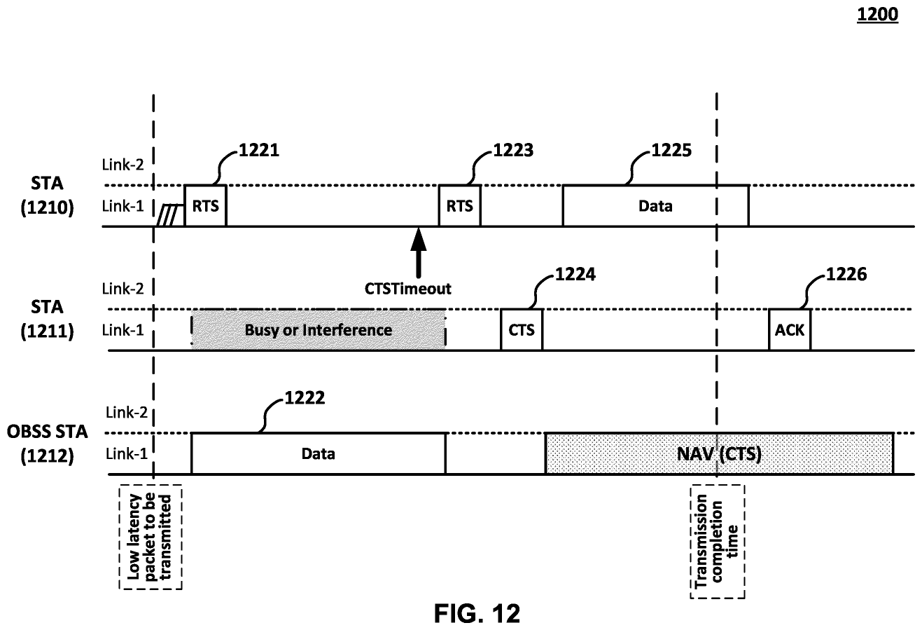

In addition to supporting the QoS requirements of low latency traffic, future IEEE 802.11 radios (e.g., Ultra-High Reliability (UHR) 802.11 radios) are also expected to support reliable communication of low latency traffic. Reliability may be achieved by using the RTS/CTS procedure before transmitting low latency data to protect the transmission of the low latency data from interference. However, while satisfying reliability, the low latency data may be delayed when a receiving STA is unavailable to respond to the RTS frame. FIG. 12 described below is an example 1200 that illustrates an existing procedure which may be used to transmit low latency data protected by an RTS/CTS exchange.

As shown in FIG. 12, example 1200 includes STAs 1210 and 1211 and an OBSS STA 1212. OBSS STA 1212 may belong to a different BSS than STAs 1210 and 1211. STAs 1210 and 1211 may each comprise an AP MLD or a non-AP MLD capable of communicating over multiple links. Similarly, OBSS STA 1212 may comprise an AP MLD or a non-AP MLD capable of communicating over multiple links. In an example, OBSS STA 1212 may be within the communication range of STA 1211 but may not be within the communication range of STA 1210.

In example 1200, STA 1210 may have a low latency data frame 1225 to transmit to STA 1211 within a transmission completion time. A low latency data frame may be a data frame that comprises one or more MPDUs having LL TIDs. In an implementation, STA 1210 may associate a counter with the transmission completion time. The transmission completion time counter may start with the arrival at STA 1210 of the low latency data being transmitted in low latency data frame 1225. In another implementation, the transmission completion time counter may start with the initiation of an RTS/CTS procedure by STA 1210. In another implementation, the transmission completion time counter may start with the transmission of low latency data frame 1225 by STA 1210. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

According to the existing procedure, to transmit low latency data frame 1225, STA 1210 may first transmit an RTS frame 1221 to STA 1211 via a first link (e.g., Link-1). In an example, STA 1210 may start the transmission completion time counter associated with low latency data frame 1225 on transmitting RTS frame 1221. In an example, STA 1211 may not transmit a CTS frame to STA 1210 in response to RTS frame 1221 via the first link due to being in the process of receiving a data frame 1222 from OBSS STA 1212 at the time of receiving RTS frame 1221 from STA 1210. In another example, OBSS STA 1212 may be transmitting data frame 1222 to another STA (not shown in FIG. 12) via the first link and STA 1211 may have set its NAV based on data frame 1222 due to being within the communication range of OBSS STA 1212.

In an example, an RTS/CTS timer may expire at STA 1210 before STA 1211 transmits a CTS frame to STA 1210 via the first link. In an example, the RTS/CTS timer may be initialized with the value of a CTS timeout interval. The CTS timeout interval may represent a time interval that starts from the transmission of an RTS frame by a STA. At the expiration of the CTS timeout interval without receiving a CTS frame in response to the RTS frame, the STA may conclude that the RTS/CTS procedure has failed. The CTS timeout interval may be equal to the duration of aSIFSTime+aSlotTime+aRxPHYStartDelay as described in section 10.3.2.9 of the IEEE 802.11 standard (“IEEE P802.11-REVme™/D2.1, January 2023”). Here, aSIFSTime represents the nominal time (in microseconds) that the MAC and PHY layers require from reception of the end of a first PPDU[+SigExt] on the wireless medium, until the MAC and PHY layers process any frame(s) therein and respond with the start on the wireless medium of a second PPDU containing the earliest possible response frame; aSlotTime represents the slot time (in microseconds) that the MAC uses for defining interframe spaces; aRxPHYStartDelay represents the delay, in microseconds, from the start of the PPDU at a receiver's antenna to the issuance of the PHY-RXSTART.indication primitive.

According to the existing procedure, STA 1210 may transmit a further RTS frame 1223 to STA 1211 via the first link. In an example, STA 1211 may respond to RTS frame 1223 by transmitting a CTS frame 1224 to STA 1210 via the first link, if its NAV indicates idle. By hearing the CTS frame, OBSS STA 1212 may set its NAV for the first link. Meanwhile, STA 1210 may transmit low latency data frame 1225 to STA 1211 via the first link. STA 1211 may transmit an ACK frame 1226 to STA 1210 via the first link after receiving low latency data frame 1225.

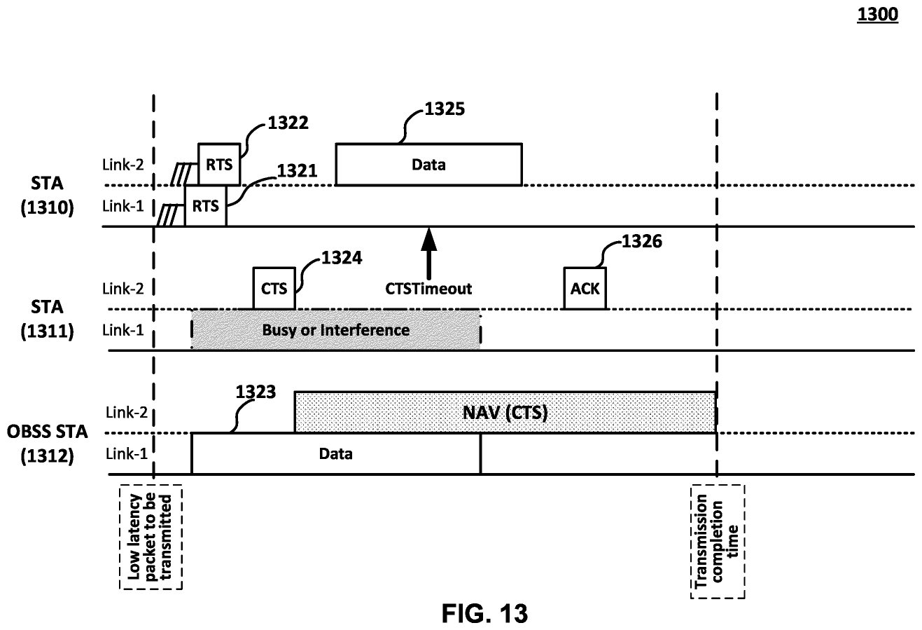

As illustrated in FIG. 12, because of the potential delay that may arise due to the RTS/CTS protection procedure in a busy link, the elapsed time from the transmission of RTS frame 1221 by STA 1210 to the reception of ACK frame 1226 by STA 1210 may be greater than the transmission completion time of low latency data frame 1225. For low latency data frames, delayed transmission may be useless as the frames may no longer be useful for the receiving STA. In one approach, a STA with multi-link capability may request the transmission of low latency data from an available link, if any, by sending RTS frames over multiple links. FIG. 13 described below is an example 1300 that illustrates another existing procedure which may be used to transmit low latency data protected by an RTS/CTS exchange.

As shown in FIG. 13, example 1300 includes STAs 1310 and 1311 and an OBSS STA 1312. OBSS STA 1312 may belong to a different BSS than STAs 1310 and 1311. STAs 1310 and 1311 may each comprise an AP MLD or a non-AP MLD capable of communicating over multiple links. Similarly, OBSS STA 1312 may comprise an AP MLD or a non-AP MLD capable of communicating over multiple links. In an example, OBSS STA 1312 may be within the communication range of STA 1311 but may not be within the communication range of STA 1310.

In example 1300, STA 1310 may have a low latency data frame 1325 to transmit to STA 1311 within a transmission completion time. A low latency data frame may be a data frame that comprises one or more MPDUs having LL TIDs. In an implementation, STA 1310 may associate a counter with the transmission completion time. The transmission completion time counter may start with the arrival at STA 1310 of the low latency data being transmitted in low latency data frame 1325. In another implementation, the transmission completion time counter may start with the initiation of an RTS/CTS procedure by STA 1310. In another implementation, the transmission completion time counter may start with the transmission of low latency data frame 1325 by STA 1310. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

According to the existing procedure, to transmit low latency data frame 1325, STA 1310 may transmit an RTS frame 1321 to STA 1311 via the first link and another RTS frame 1322 to STA 1311 via the second link (e.g., Link-2). STA 1310 may initiate the transmissions of RTS frames 1321 and 1322 simultaneously. Due to random backoffs over the first link and the second link, the transmissions of RTS frames 1321 and 1322 may or not be aligned in time. In an example, STA 1310 may start the transmission completion time counter associated with low latency data frame 1325 on transmitting RTS frame 1321.

In an example, STA 1311 may not transmit a CTS frame to STA 1310 in response to RTS frame 1321 via the first link due to being in the process of receiving a data frame 1323 from OBSS STA 1312 at the time of receiving RTS frame 1321 from STA 1310. In another example, OBSS STA 1312 may be transmitting data frame 1323 to another STA (not shown in FIG. 13) via the first link and STA 1311 may have set its NAV based on data frame 1323 due to being within the communication range of OBSS STA 1312. However, STA 1311 may respond to RTS frame 1322 by transmitting a CTS frame 1324 to STA 1310 via the second link, if its NAV indicates idle. By hearing CTS frame 1324, OBSS STA 1312 may set its NAV for the second link. After receiving CTS frame 1324, STA 1310 may transmit low latency data frame 1325 to STA 1311 via the second link. STA 1311 may transmit an ACK frame 1326 to STA 1310 via the second link after receiving data frame 1325. Meanwhile, after the transmission of RTS frame 1321 via the first link, STA 1310 may observe the expiry of the CTS timeout interval if does not receive a CTS frame via the first link. As data frame 1325 is transmitted via the second link, STA 1310 does not transmit a further RTS frame over the first link.

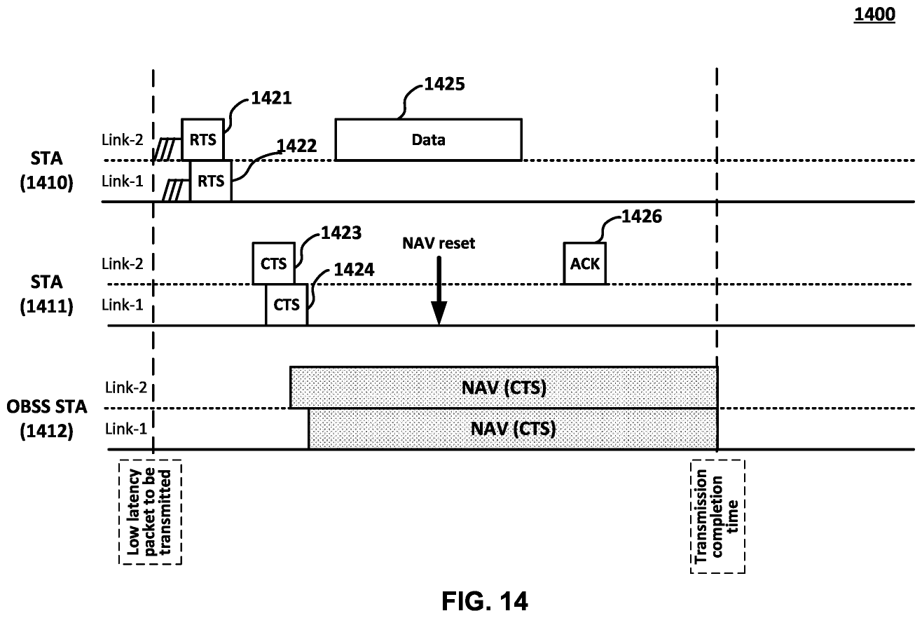

As illustrated in FIG. 13, by transmitting multiple RTS frames via multiple links (to request transmission of low latency data) and receiving a CTS frame from one of the links, the elapsed time from the transmission of RTS frame 1321 by STA 1310 to the reception of ACK frame 1326 by STA 1310 may be less than the transmission completion time. In the scenario in which one or more links are busy/unavailable and only one link is available, as illustrated in FIG. 13, transmitting multiple RTS frames via multiple links may provide an efficient solution for low latency data transmission. However, in the scenario in which multiple links are available, the transmission of multiple RTS frames may cause STAs within the communication range of the receiving STA (OBSS STAs and/or other STAs in the same BSS) to set their NAVs for all links over which they hear CTS frames from the receiving STA. However, as the transmitting STA transmits the data frame over only one link, the STAs within the communication range of the receiving STA may refrain unnecessarily from communication over the other links. FIG. 14 described below is an example 1400 that illustrates another existing procedure which may be used to transmit low latency data protected by an RTS/CTS exchange.

As shown in FIG. 14, example 1400 includes STAs 1410 and 1411 and an OBSS STA 1412. OBSS STA 1412 may belong to a different BSS than STAs 1410 and 1411. STAs 1410 and 1411 may each comprise an AP MLD or a non-AP MLD capable of communicating over multiple links. Similarly, OBSS STA 1412 may comprise an AP MLD or a non-AP MLD capable of communicating over multiple links. In an example, OBSS STA 1412 may be within the communication range of STA 1411 but may not be within the communication range of STA 1410.

In example 1400, STA 1410 may have a low latency data frame 1425 to transmit to STA 1411 within a transmission completion time. A low latency data frame may be a data frame that comprises one or more MPDUs having LL TIDs. In an implementation, STA 1410 may associate a counter with the transmission completion time. The transmission completion time counter may start with the arrival at STA 1410 of the low latency data being transmitted in low latency data frame 1425. In another implementation, the transmission completion time counter may start with the initiation of an RTS/CTS procedure by STA 1410. In another implementation, the transmission completion time counter may start with the transmission of low latency data frame 1425 by STA 1410. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

According to the existing procedure, to transmit low latency data frame 1425, STA 1410 may transmit an RTS frame 1421 to STA 1411 via the second link and another RTS frame 1422 to STA 1411 via the first link. STA 1410 may initiate the transmissions of RTS frames 1421 and 1422 simultaneously. Due to random backoffs over the first link and the second link, the transmissions of RTS frames 1421 and 1422 may or not be aligned in time. In an example, STA 1410 may start the transmission completion time counter associated with low latency data frame 1425 on transmitting RTS frame 1421.

In an example, STA 1411 may transmit a CTS frame 1423 to STA 1410 in response to RTS frame 1421 via the second link, if its NAV indicates idle. STA 1411 may also respond to RTS frame 1422 by transmitting a CTS frame 1424 to STA 1410 via the first link, if its NAV indicates idle. On hearing CTS frame 1423 via the second link and CTS frame 1424 via the first link, OBSS STA 1412 may set its NAVs for the first link and the second link based on CTS frames 1423 and 1424, respectively. After receiving CTS frame 1423 over the second link (for example, STA 1410 receives the CTS frame 1423 via the second link earlier than the CTS frame 1424 via the first link), STA 1410 may transmit a data frame 1425 to STA 1411 via the second link. STA 1411 may transmit an ACK frame 1426 to STA 1410 via the second link after receiving data frame 1425. Meanwhile, after the transmission of CTS frame 1424 via the first link, if STA 1411 does not receive a data frame via the first link within the duration of (2×aSIFSTime)+CTS_Time+aRxPHYStartDelay+(2×aSlotTime), STA 1411 may reset its own NAV for the first link. CTS_Time represents the transmission time of CTS frame 1424. On the other hand, OBSS STAs (e.g., OBSS STA 1412) and other STAs in the same BSS as STA 1411 cannot reset their NAVs for the first link and thus cannot communicate via the first link despite the first link not being used for any frame transmission. As such, although the low latency data may be transmitted before the transmission completion time, many STAs may become unavailable over the first link despite the first link not being used.

Embodiments of the present disclosure, as further described below, address the above-described problems of existing procedures. In one aspect, embodiments enable a STA (AP STA or non-AP STA) having a multi-link capability to leverage the availability of a second link for the transmission of low latency data when successful protection of the transmission via a first link becomes improbable. In another aspect, the STA may leverage the availability of the second link in addition to the first link based on a remaining time for the transmission of the low latency data within a transmission completion time. In a further aspect, embodiments enable a receiving STA to respond via one link only to multiple RTS frames received via multiple links. As such, other STAs within the communication range of the receiving STA are not unnecessarily blocked from communication over the other links.

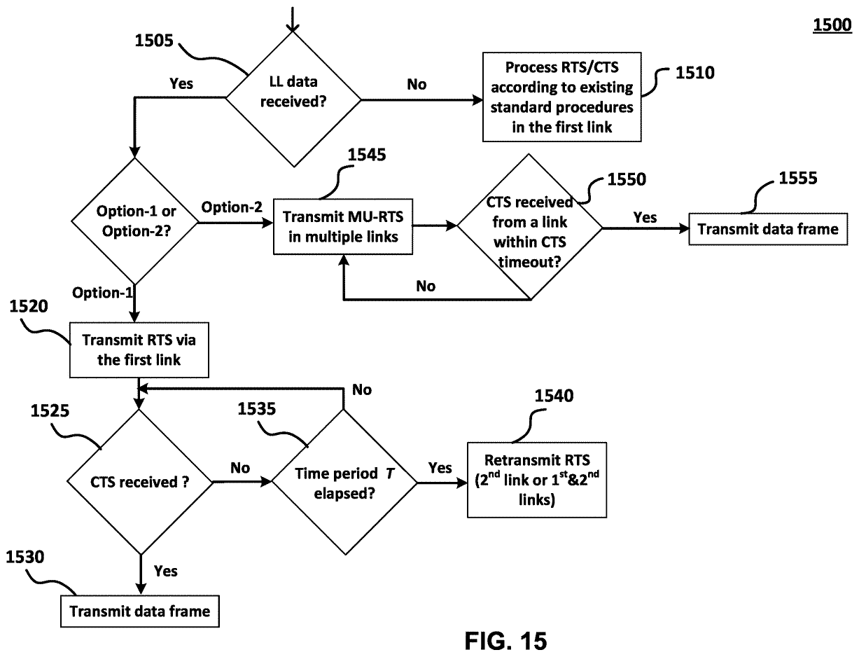

FIG. 15 illustrates an example process 1500 according to an embodiment. Example process 1500 is provided for the purpose of illustration only and is not limiting of embodiments. Example process 1500 may be performed by a first STA having a multi-link capability (i.e., comprising a multi-link device (MLD)). The first STA may be an AP STA or a non-AP STA. The first STA may be a transmitting STA that has data for transmission to a second STA (receiving STA). The second STA may also comprise an MLD. The first STA and the second STA may communicate over at least a first link and a second link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

As shown in FIG. 15, process 1500 may start in step 1505, which includes determining whether data to be transmitted to a second STA comprises low latency traffic. As used herein, low latency traffic may refer to traffic associated with one or more predetermined traffic categories or traffic streams (e.g., voice/video). The low latency traffic may comprise data frames having LL TIDs. If the answer is no in step 1505, process 1500 proceeds to step 1510, in which the STA processes the data according to existing IEEE 802.11 standard procedures. For example, the STA may use existing RTS/CTS procedures as defined in the existing standard before transmitting the data.

Otherwise, if the answer is yes in step 1505, process 1500 may transition, according to a first option (hereinafter Option-1), to step 1520 or, according to a second option (hereinafter Option-2), to step 1545.

Step 1520 includes transmitting to the second STA via the first link a first RTS frame requesting the transmission of the data comprising low latency traffic. Subsequently, process 1500 proceeds to step 1525, which includes checking whether a CTS frame is received via the first link from the second STA. If the answer is yes in step 1525, process 1500 may transition to step 1530, which includes transmitting the data comprising low latency traffic to the second STA via the first link.

Otherwise, if the answer is no in step 1525, process 1500 may transition to step 1535, which includes determining whether a time period T has elapsed. In an embodiment, time period T may be used as an early check of whether a transmission request over a link has been accepted. The early check ensures that, if the transmission request has not yet been accepted, the data comprising low latency traffic can still be transmitted within a transmission completion time via another link. In an embodiment, time period, T, is set according to the equation T<=Transmission completion duration−data transmission duration−ACK transmission duration−RTS/CTS exchange duration−4×SIFS duration−a maximum backoff duration (Equation 1).

If the answer is no in step 1535, process 1500 may transition back to step 1525 described above.

Otherwise, if the answer is yes in step 1535, process 1500 may transition to step 1540. In a first embodiment, step 1540 includes transmitting a second RTS frame via the second link to the second STA. In an embodiment, time period T may be less than a CTS timeout interval according to this first embodiment. The second RTS frame requests transmission of the data comprising low latency traffic, via the second link, to the second STA. In response, the first STA may receive from the second STA, via the second link, a CTS frame in response to the second RTS frame. The first STA may transmit to the second STA, the data comprising low latency traffic, via the second link.

In a second embodiment, step 1540 includes, in addition to transmitting to the second STA the second RTS frame via the second link, transmitting to the second STA a third RTS frame via the first link. In an embodiment, the time period T may be greater than or equal to a CTS timeout interval according to this second embodiment. The third RTS frame requests transmission of the data comprising low latency traffic, via the first link, to the second STA. Hence, the third RTS frame may overlap in time with the second RTS frame. In an embodiment, the second and third RTS frames may comprise multi-user request-to-send (MU-RTS) trigger frames. In an embodiment, the first STA may receive from the second STA, via the second link, a CTS frame in response to the second RTS frame and may transmit to the second STA the data comprising low latency traffic, via the second link. In another embodiment, the first STA may receive from the second STA, via the first link, a CTS frame in response to the third RTS frame.

Switching now to Option-2, step 1545 includes transmitting to the second STA, via the first link, a first MU-RTS trigger frame requesting the transmission of the data, via the first link, to the second STA; and transmitting to the second STA, via the second link, a second MU-RTS trigger frame requesting the transmission of the data, via the second link, to the second STA.

In an embodiment, the first MU-RTS trigger frame may comprise an indication of the second link. In an embodiment, the indication of the second link in the first MU-RTS trigger frame indicates to the second STA that the second MU-RTS trigger frame transmitted via the second link requests transmission of same data as the first MU-RTS trigger frame transmitted via the first link. In another embodiment, the second MU-RTS trigger frame may comprise an indication of the first link. In an embodiment, the indication of the first link in the second MU-RTS trigger frame indicates to the second STA that the first MU-RTS trigger frame transmitted via the first link requests transmission of same data as the second MU-RTS trigger frame transmitted via the second link. Such an indication in the first MU-RTS trigger frame or the second MU-RTS trigger frame allows the second STA to link the first and second MU-RTS trigger frames as concerning the same data.

In an embodiment, the first MU-RTS trigger frame and/or the second MU-RTS trigger frame may comprise an indication of a CTS reply option for use by the second STA. In an embodiment, the CTS reply option may comprise the second STA responding to one of the first MU-RTS trigger frame or the second MU-RTS trigger frame. Alternatively, the CTS reply option may comprise the second STA responding to the first MU-RTS trigger frame and second MU-RTS trigger frame.

Subsequently, process 1500 proceeds to step 1550, which includes determining whether a CTS frame is received over the first or second link within a CTS timeout interval. If the answer is no in step 1550, process 1500 returns to step 1545 described above. Otherwise, if the answer is yes in step 1550, that is the STA receives from the second STA, a CTS frame, via one of the first and second links (e.g., via the second link, in response to the second MU-RTS trigger frame), the STA may transmit to the second STA, via the corresponding link (e.g., via the second link, in response to the CTS frame), a data frame comprising the data.

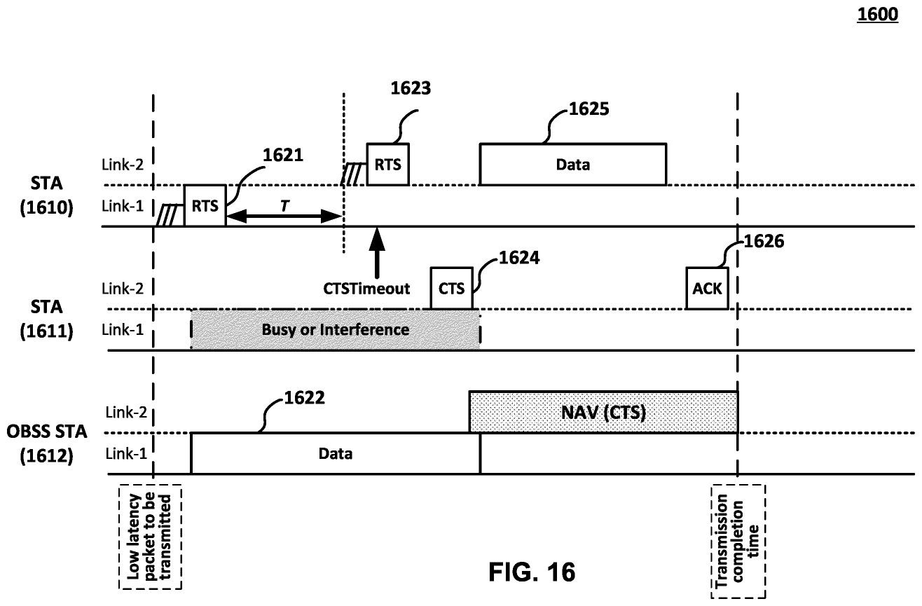

FIG. 16 illustrates an example 1600 of a proposed procedure which may be used to transmit low latency data protected by an RTS/CTS exchange according to an embodiment. As shown in FIG. 16, example 1600 includes STAs 1610 and 1611 and an OBSS STA 1612. OBSS STA 1612 may belong to a different BSS than STAs 1610 and 1611. STAs 1610 and 1611 may each comprise an AP MLD or a non-AP MLD capable of communicating over multiple links. Similarly, OBSS STA 1612 may comprise an AP MLD or a non-AP MLD capable of communicating over multiple links. In an example, OBSS STA 1612 may be within the communication range of STA 1611 but may not be within the communication range of STA 1610.

In example 1600, STA 1610 may have a low latency data frame 1625 to transmit to STA 1611 within a transmission completion time. A low latency data frame may be a data frame that comprises one or more MPDUs having LL TIDs. In an implementation, STA 1610 may associate a counter with the transmission completion time. The transmission completion time counter may start with the arrival at STA 1610 of the low latency data being transmitted in low latency data frame 1625. In another implementation, the transmission completion time counter may start with the initiation of an RTS/CTS procedure by STA 1610. In another implementation, the transmission completion time counter may start with the transmission of low latency data frame 1625 by STA 1610. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

In order to transmit a low latency data frame 1625, STA 1610 may transmit to STA 1611, via the first link, an RTS frame 1621 requesting transmission of data comprising low latency traffic via the first link to STA 1611. In an example, STA 1610 may start the transmission completion time counter associated with low latency data frame 1625 on transmitting RTS frame 1621. In an example, STA 1611 may not transmit a CTS frame to STA 1610 in response to RTS frame 1621 via the first link due to being in the process of receiving a data frame 1622 from OBSS STA 1612 at the time of receiving RTS frame 1621 from STA 1610. In another example, OBSS STA 1612 may be transmitting a data frame 1622 to another STA (not shown in FIG. 16) via the first link and STA 1611 may have its NAV set due to being within the communication range of OBSS STA 1612.

In an embodiment, based on STA 1610 not receiving a CTS frame from STA 1611 within a time period T from transmission of RTS frame 1621 and data frame 1625 comprising low latency traffic, STA 1610 may transmit to STA 1611, via the second link, an RTS frame 1623 requesting transmission of data frame 1625, via the second link, to STA 1611. In an embodiment, the time period T is set to a value that is lower than a CTS timeout interval (and in accordance with Equation (1) described above). In an example, the time period T may be set to ½ CTS timeout interval value. In another example, the time period T may be set to ⅓ CTS timeout interval value. As such, time period T may be used to perform an early check of whether the RTS/CTS exchange succeeded over the first link. The early check may provide a hint of whether the RTS/CTS exchange over the first link will be successful. Based on the early check, STA 1611 may immediately initiate the RTS/CTS exchange over the second link to increase the chances of transmission of the low latency traffic.

In an embodiment, STA 1610 may not transmit another RTS frame via the first link after the CTS timeout interval. In an embodiment, if the NAV indicates idle for the second link for STA 1611, STA 1610 may receive from STA 1611, via the second link, a CTS frame 1624 in response to RTS frame 1623. On hearing CTS frame 1624, OBSS STA 1612 may set its NAV for the second link based on CTS frame 1624. STA 1610 may then transmit to STA 1611 data frame 1625 via the second link. STA 1611 may transmit an ACK frame 1626 to STA 1610 via the second link after receiving data frame 1625.

As illustrated in FIG. 16, using the proposed procedure, STA 1611 receives the data comprising low latency traffic within the transmission completion time. This is enabled by the STA 1611 switching to the second link to perform the RTS/CTS exchange after the time period T has elapsed. The time period T being less than the CTS timeout interval ensures that STA 1611 initiates the RTS/CTS exchange over the second link based on an early check of whether the RTS/CTS exchange succeeded over the first link. This early initiation of the RTS/CTS exchange over the second link allows STA 1611 to postpone resort to the brute force approach of transmission of multiple RTS frames via multiple links.

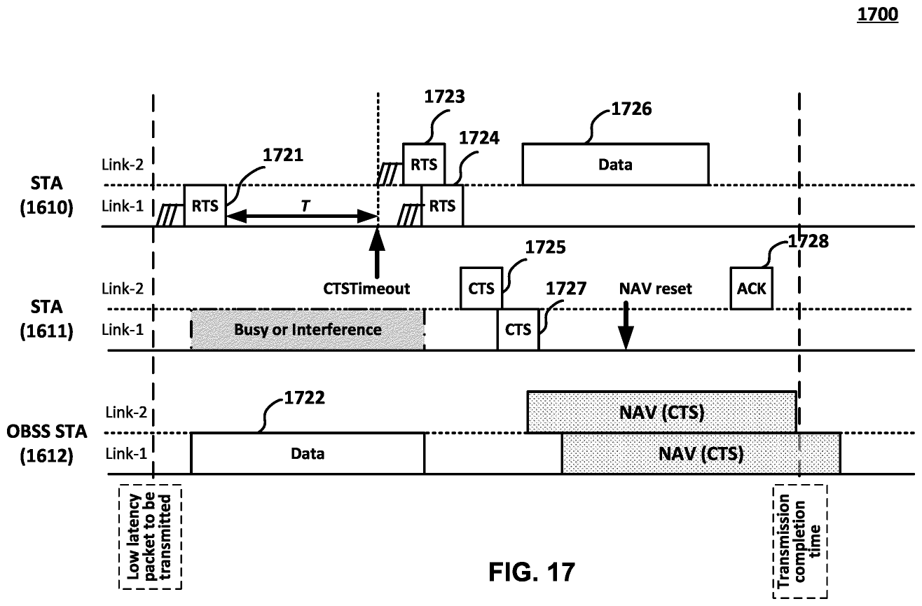

FIG. 17 illustrates another example 1700 of a proposed procedure which may be used to transmit low latency data protected by an RTS/CTS exchange according to an embodiment. As shown in FIG. 17, example 1600 includes STAs 1610 and 1611 and an OBSS STA 1612. OBSS STA 1612 may belong to a different BSS than STAs 1610 and 1611. STAs 1610 and 1611 may each comprise an AP MLD or a non-AP MLD capable of communicating over multiple links. Similarly, OBSS STA 1612 may comprise an AP MLD or a non-AP MLD capable of communicating over multiple links. In an example, OBSS STA 1612 may be within the communication range of STA 1611 but may not be within the communication range of STA 1610.

In order to transmit a low latency data frame 1726, STA 1610 may transmit to STA 1611, via the first link, an RTS frame 1721 requesting transmission of data comprising low latency traffic via the first link to STA 1611. In an example, STA 1610 may start the transmission completion time counter associated with low latency data frame 1726 on transmitting RTS frame 1721. In an example, STA 1611 may not transmit a CTS frame to STA 1610 in response to RTS frame 1721 via the first link due to being in the process of receiving a data frame 1722 from OBSS STA 1612 at the time of receiving RTS frame 1721 from STA 1610. In another example, OBSS STA 1612 may be transmitting a data frame 1722 to another STA (not shown in FIG. 17) via the first link and STA 1611 may have its NAV set due to being within the communication range of OBSS STA 1612.

In an embodiment, based on STA 1610 not receiving a CTS frame from STA 1611 within a time period T from transmission of the RTS frame 1721 and the data frame 1726 comprising low latency traffic, STA 1610 may transmit to STA 1611, via the second link, an RTS frame 1723 requesting transmission of data frame 1726, via the second link, to STA 1611. In an embodiment, the time period T may be greater than or equal to a CTS timeout interval (and in accordance with Equation (1) described above). In an embodiment, when the time period Tis greater than or equal to the CTS timeout interval, STA 1610 may further transmit to STA 1611, via the first link, RTS frame 1724 requesting transmission of data frame 1726, via the first link, to STA 1611. In an embodiment, RTS frame 1724 may overlap in time with RTS frame 1723.

In an embodiment, STA 1610 may receive from STA 1611, via the second link, CTS frame 1725 in response to RTS frame 1723. By hearing CTS frame 1725, OBSS STA 1612 may set its NAV for the second link based on CTS frame 1725. STA 1610 may then transmit to STA 1611 data frame 1726 via the second link. In another embodiment, STA 1610 may receive from STA 1611, via the first link, CTS frame 1727 in response to RTS frame 1724. By hearing CTS frame 1727, OBSS STA 1612 may set its NAV for the first link based on CTS frame 1727. In an embodiment, STA 1610 may receive CTS frame 1727 after receiving CTS frame 1725. Accordingly, as STA 1610 may have already begun transmitting data frame 1726 via the second link, STA 1610 may not respond to CTS frame 1727 via the first link. In an embodiment, if STA 1611 does not receive a data frame via a link after STA 1611 transmits a CTS frame via the link, STA 1611 may reset its NAV for the link. As such, in example 1700, STA 1611 may reset its NAV for the first link based on receiving a data frame in response to CTS frame 1727. On receiving data frame 1726, STA 1611 may transmit an ACK frame 1728 to STA 1610 via the second link.

As illustrated in FIG. 17, using the proposed procedure, the second STA receives the data comprising low latency traffic within the transmission completion time. This is enabled by the first STA transmitting multiple RTS frames via multiple links, after the time period T has elapsed. The time period T being greater than or equal to the CTS timeout interval ensures that the first STA only resorts to multiple RTS transmissions via multiple links when the first RTS/CTS exchange via the first link has failed. That is, the STA resorts to the brute-force approach of multiple RTS transmissions via multiple links when the remaining time window for performing the low latency data transmission has become narrower.

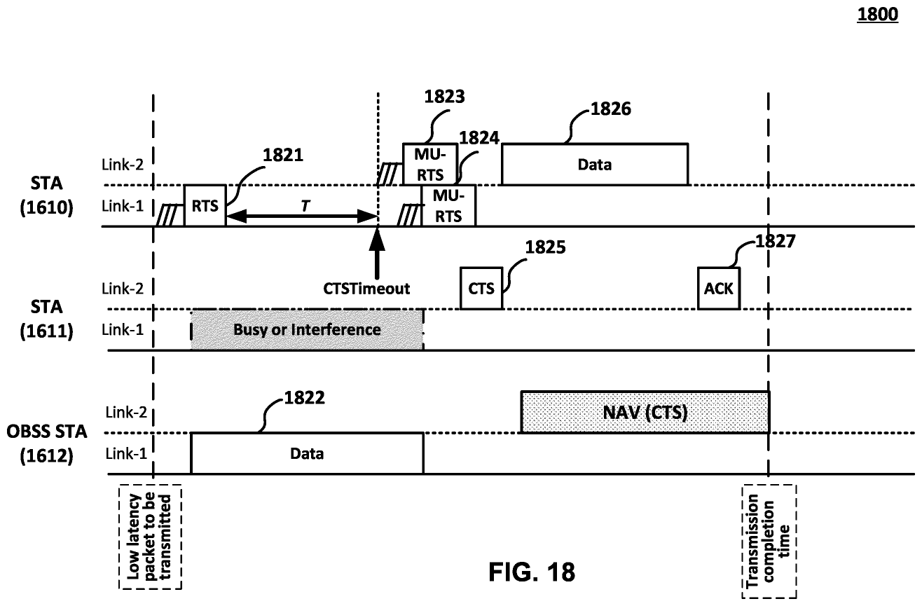

However, although the data comprising low latency traffic is transmitted via the second link only and that the first link is unused, OBSS STA 1612 cannot reset its NAV for the first link due to hearing CTS frame 1727 over the first link. This may also be the case for any STA within the communication range of STA 1611 and such a STA cannot communicate via the first link despite the first link not being used for any frame transmission. FIG. 18 described below provides an example solution to this problem.

FIG. 18 illustrates another example 1800 of a proposed procedure which may be used to transmit low latency data protected by an RTS/CTS exchange according to an embodiment. As shown in FIG. 18, example 1800 includes STAs 1610 and 1611 and an OBSS STA 1612. OBSS STA 1612 may belong to a different BSS than STAs 1610 and 1611. STAs 1610 and 1611 may each comprise an AP MLD or a non-AP MLD capable of communicating over multiple links. Similarly, OBSS STA 1612 may comprise an AP MLD or a non-AP MLD capable of communicating over multiple links. In an example, OBSS STA 1612 may be within the communication range of STA 1611 but may not be within the communication range of STA 1610.

In order to transmit a low latency data frame 1826, STA 1610 may transmit to STA 1611, via the first link, an RTS frame 1821 requesting transmission of data comprising low latency traffic via the first link to STA 1611. In an example, STA 1610 may start the transmission completion time counter associated with low latency data frame 1826 on transmitting RTS frame 1821. In an example, STA 1611 may not transmit a CTS frame to STA 1610 in response to RTS frame 1821 via the first link due to being in the process of receiving a data frame 1822 from OBSS STA 1612 at the time of receiving RTS frame 1821 from STA 1610. In another example, OBSS STA 1612 may be transmitting a data frame 1822 to another STA (not shown in FIG. 18) via the first link and STA 1611 may have its NAV set due to being within the communication range of OBSS STA 1612.

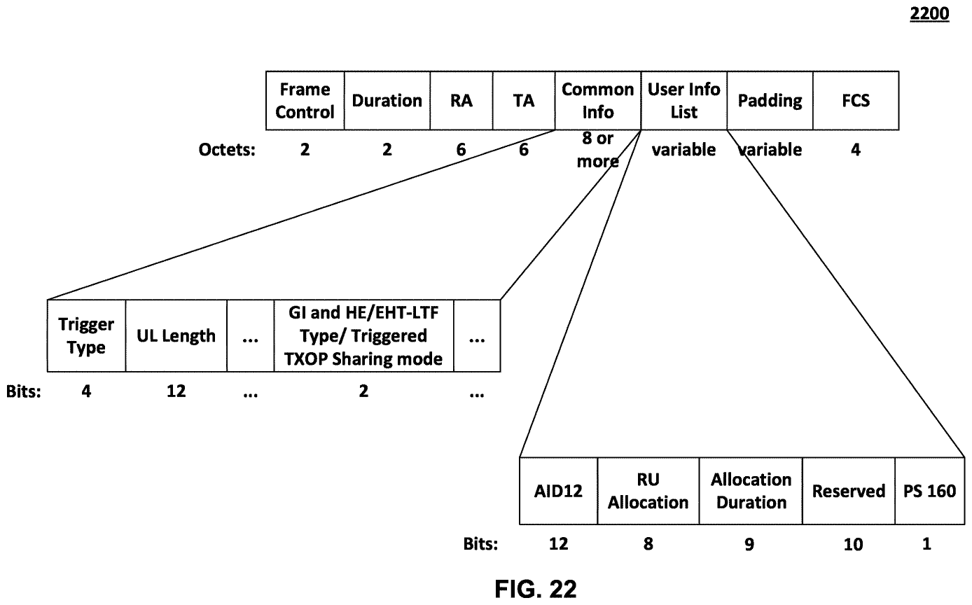

In an embodiment, based on STA 1610 not receiving a CTS frame from STA 1611 within a time period T from transmission of the RTS frame 1821 and the data frame 1826 comprising low latency traffic, STA 1610 may transmit to STA 1611, via the second link, an MU-RTS trigger frame 1823 requesting transmission of data frame 1826, via the second link, to STA 1611. In an embodiment, the time period T may be greater than or equal to a CTS timeout interval (and in accordance with Equation (1) described above). In an embodiment, when the time period T is greater than or equal to the CTS timeout interval, STA 1610 may further transmit to STA 1611, via the first link, MU-RTS trigger frame 1824 requesting transmission of data frame 1826, via the first link, to STA 1611. In an embodiment, MU-RTS trigger frame 1824 may overlap in time with MU-RTS trigger frame 1823. In an embodiment, MU-RTS trigger frame 1823 and/or MU-RTS trigger frame 1824 may have a format like trigger frame 2200 described further below with respect to FIG. 22.

In an embodiment, STA 1611 may receive MU-RTS trigger frame 1823 via the second link before receiving MU-RTS trigger frame 1824 via the first link. In an embodiment, STA 1611 may respond to MU-RTS trigger frame 1823 by transmitting a CTS frame 1825 via the second link, if the NAV indicates idle. In another embodiment, STA 1611 may receive MU-RTS trigger frame 1823 via the second link at the same time or later than MU-RTS trigger frame 1824 via the first link. In an embodiment, STA 1611 may choose an appropriate link (e.g., the second link) for CTS transmission (e.g., depending on traffic parameters) and may transmit only one CTS frame via the chosen link (e.g., the second link). Choosing only one appropriate link for CTS transmission may be triggered by the MU-RTS frames 1823 and 1824 having a special format as defined in FIG. 22. In an embodiment, MU-RTS trigger frame 1823 or MU-RTS trigger frame 1824 may comprise an indication of a CTS reply option for use by STA 1611. In an embodiment, the CTS reply option may comprise STA 1611 responding to either MU-RTS trigger frame 1823 or MU-RTS trigger frame 1824. In another embodiment, the CTS reply option may comprise STA 1611 responding to MU-RTS trigger frame 1823 and MU-RTS trigger frame 1824.

In an embodiment, STA 1610 may receive from STA 1611, via the second link, a CTS frame 1825 in response to the MU-RTS trigger frame 1823. On hearing the CTS frame 1825, OBSS STA 1612 may set its NAV for the second link. STA 1610 may then transmit to STA 1611 data frame 1826 via the second link. On receiving data frame 1826, STA 1611 may transmit an ACK frame 1827 to STA 1610 via the second link.

As illustrated in FIG. 18, using MU-RTS trigger frames (instead of RTS frames) in the proposed procedure, STA 1611 transmits a single CTS frame, via the second link, in response to the multiple MU-RTS trigger frames. OBSS STA 1612 thus does not set its NAV unnecessarily for the first link, allowing other transmissions (e.g., involving OBSS STA 1612) to take place over the first link.

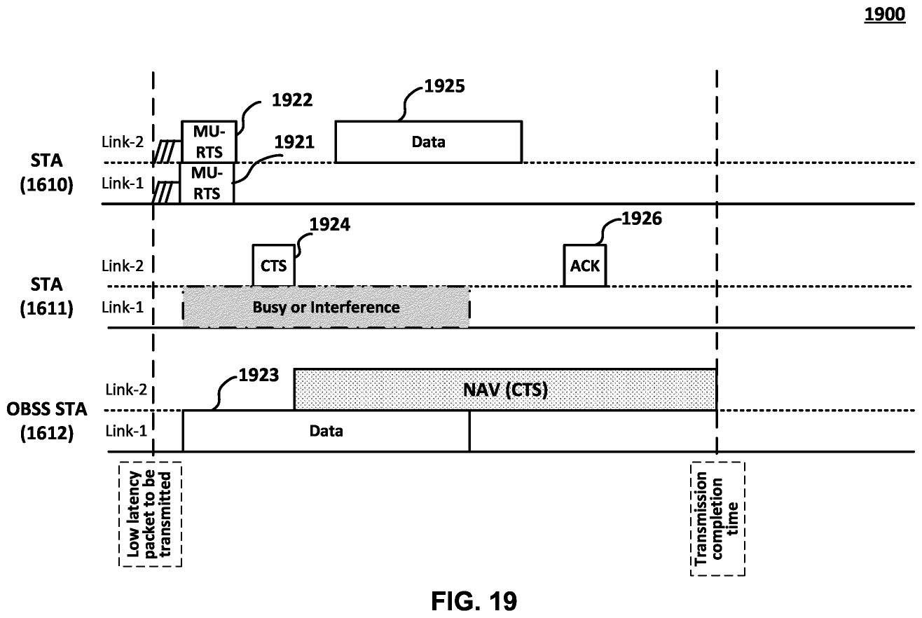

FIG. 19 illustrates another example 1900 of a proposed procedure which may be used to transmit low latency data protected by an RTS/CTS exchange according to an embodiment. As shown in FIG. 19, example 1900 includes STAs 1610 and 1611 and an OBSS STA 1612. OBSS STA 1612 may belong to a different BSS than STAs 1610 and 1611. STAs 1610 and 1611 may each comprise an AP MLD or a non-AP MLD capable of communicating over multiple links. Similarly, OBSS STA 1612 may comprise an AP MLD or a non-AP MLD capable of communicating over multiple links. In an example, OBSS STA 1612 may be within the communication range of STA 1611 but may not be within the communication range of STA 1610.

In an embodiment, STA 1610 may receive data for transmission to STA 1611. Based on the data comprising low latency traffic, STA 1610 may transmit an MU-RTS trigger frame 1921, via the first link, requesting transmission of the data, via the first link to STA 1611, and an MU-RTS trigger frame 1922, via the second link, requesting transmission of the data, via the second link to STA 1611. In an embodiment, MU-RTS trigger frame 1921 and/or MU-RTS trigger frame 1922 may have a format like trigger frame 2200 described further below with respect to FIG. 22. In an embodiment, MU-RTS trigger frame 1921 may comprise an indication of the second link. In an embodiment, the indication of the second link in MU-RTS trigger frame 1921 may indicate to STA 1611 that MU-RTS trigger frame 1922 transmitted via the second link requests transmission of same data as MU-RTS trigger frame 1921 transmitted via the first link. In another embodiment, MU-RTS trigger frame 1922 may comprise an indication of the first link. In an embodiment, the indication of the first link in MU-RTS trigger frame 1922 may indicate to STA 1611 that MU-RTS trigger frame 1921 transmitted via the first link requests transmission of same data as MU-RTS trigger frame 1922 transmitted via the second link. Such an indication in MU-RTS trigger frame 1921 or MU-RTS trigger frame 1922 allows STA 1611 to link MU-RTS trigger frames 1921 and 1922 as concerning the same data.

In another embodiment, MU-RTS trigger frame 1921 or MU-RTS trigger frame 1922 may comprise an indication of a CTS reply option for use by STA 1611. In an embodiment, the CTS reply option may comprise STA 1611 responding to either MU-RTS trigger frame 1921 or MU-RTS trigger frame 1922. In another embodiment, the CTS reply option may comprise STA 1611 responding to MU-RTS trigger frame 1921 and MU-RTS trigger frame 1922.

In an embodiment, STA 1611 may not transmit a CTS frame to STA 1610 in response to MU-RTS frame 1921 via the first link due to STA 1611 being in the process of receiving a data frame 1923 from OBSS STA 1612 at the time of receiving MU-RTS frame 1921 from STA 1610. In another example, OBSS STA 1612 may be transmitting a data frame 1923 to another STA (not shown in FIG. 19) via the first link and STA 1611 may have its NAV set based on data frame 1923 due to being within the communication range of OBSS STA 1612. In an embodiment, STA 1611 may transmit a CTS frame 1924 to STA 1610 in response to MU-RTS frame 1922 via the second link, if its NAV indicates idle. By hearing CTS frame 1924, OBSS STA 1612 may set its NAV for the second link based on CTS frame 1924. STA 1610 may then transmit to STA 1611, via the second link, a data frame 1925 comprising the data. On receiving data frame 1925, STA 1611 may transmit an ACK frame 1926 to STA 1610 via the second link.

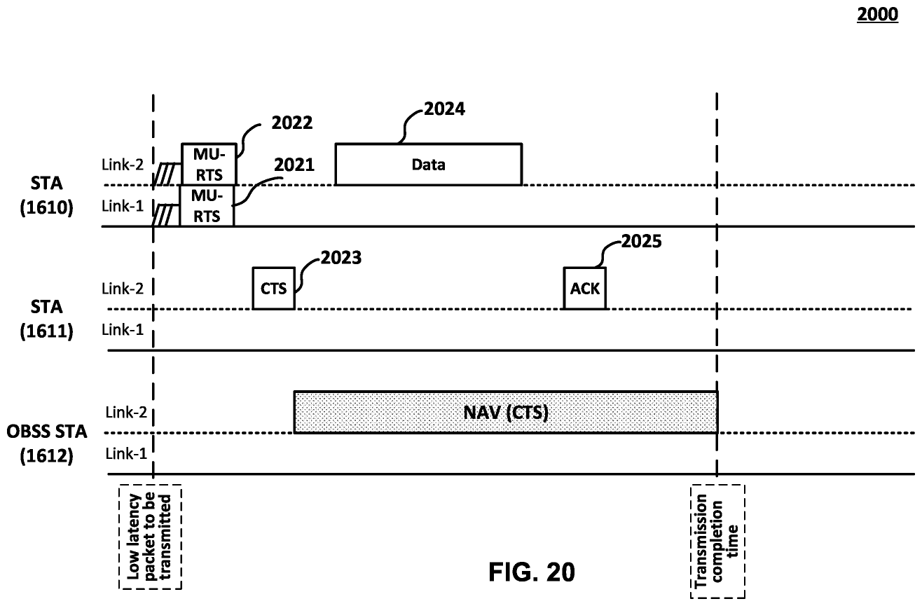

FIG. 20 illustrates another example 2000 of the procedure described in FIG. 19 according to an embodiment. As shown in FIG. 20, example 2000 includes STAs 1610 and 1611 and an OBSS STA 1612. OBSS STA 1612 may belong to a different BSS than STAs 1610 and 1611. STAs 1610 and 1611 may each comprise an AP MLD or a non-AP MLD capable of communicating over multiple links. Similarly, OBSS STA 1612 may comprise an AP MLD or a non-AP MLD capable of communicating over multiple links. In an example, OBSS STA 1612 may be within the communication range of STA 1611 but may not be within the communication range of STA 1610.

In an embodiment, STA 1610 may receive data for transmission to STA 1611. Based on the data comprising low latency traffic, STA 1610 may transmit an MU-RTS trigger frame 2021, via the first link, requesting transmission of the data, via the first link to STA 1611, and an MU-RTS trigger frame 2022, via the second link, requesting transmission of the data, via the second link to STA 1611. In an embodiment, MU-RTS trigger frame 1921 and/or MU-RTS trigger frame 1922 may have a format like trigger frame 2200 described further below with respect to FIG. 22. In an embodiment, MU-RTS trigger frame 2021 may comprise an indication of the second link. In an embodiment, the indication of the second link in MU-RTS trigger frame 2021 may indicate to STA 1611 that MU-RTS trigger frame 2022 transmitted via the second link requests transmission of same data as MU-RTS trigger frame 2021 transmitted via the first link.

In another embodiment, MU-RTS trigger frame 2022 may comprise an indication of the first link. In an embodiment, the indication of the first link in MU-RTS trigger frame 2022 may indicate to STA 1611 that MU-RTS trigger frame 2021 transmitted via the first link requests transmission of same data as MU-RTS trigger frame 2022 transmitted via the second link. Such an indication in MU-RTS trigger frame 1921 or MU-RTS trigger frame 1922 allows STA 1611 to link MU-RTS trigger frames 1921 and 1922 as concerning the same data.

In another embodiment, MU-RTS trigger frame 2021 or MU-RTS trigger frame 2022 may comprise an indication of a CTS reply option for use by STA 1611. In an embodiment, the CTS reply option may comprise STA 1611 responding to either MU-RTS trigger frame 2021 or MU-RTS trigger frame 2022. In another embodiment, the CTS reply option may comprise STA 1611 responding to MU-RTS trigger frame 2021 and MU-RTS trigger frame 2022.

In an embodiment, STA 1611 may receive MU-RTS trigger frame 2022 via the second link before receiving MU-RTS trigger frame 2021 via the first link. In an embodiment, STA 1611 may respond to MU-RTS trigger frame 2022 by transmitting a CTS frame 2023 via the second link, if the NAV indicates idle. In another embodiment, STA 1611 may receive MU-RTS trigger frame 2022 via the second link at the same time or later than MU-RTS trigger frame 2021 via the first link. In an embodiment, STA 1611 may choose an appropriate link (e.g., the second link) for CTS transmission (e.g., depending on traffic parameters) and may transmit only one CTS frame via the chosen link (e.g., the second link). Choosing only one appropriate link for CTS transmission may be triggered by the MU-RTS frames 2021 and 2022 having a special format as defined in FIG. 22. In an embodiment, MU-RTS trigger frame 2021 or MU-RTS trigger frame 2021 may comprise an indication of a CTS reply option for use by STA 1611. In an embodiment, the CTS reply option may comprise STA 1611 responding to either MU-RTS trigger frame 2021 or MU-RTS trigger frame 2022. In another embodiment, the CTS reply option may comprise STA 1611 responding to MU-RTS trigger frame 2021 and MU-RTS trigger frame 2022.

In an embodiment, STA 1610 may receive from STA 1611, via the second link, a CTS frame 2023 in response to MU-RTS trigger frame 2022. On hearing CTS frame 2023, OBSS STA 1612 may set its NAV for the second link. STA 1610 may then transmit to STA 1611 data frame 2024 via the second link. On receiving data frame 2024, STA 1611 may transmit an ACK frame 2025 to STA 1610 via the second link.

In an embodiment, by selecting the CTS reply option in which STA 1611 responds to only one of MU-RTS frames 2021 and 2022, STA 1611 transmits a single CTS frame 2023 via the second link. STAs within the communication range of STA 1611 (including OBSS STA 1612) do not set their NAVs for the first link and may communicate via the first link during the transmission of data frame 2024 and ACK frame 2025.

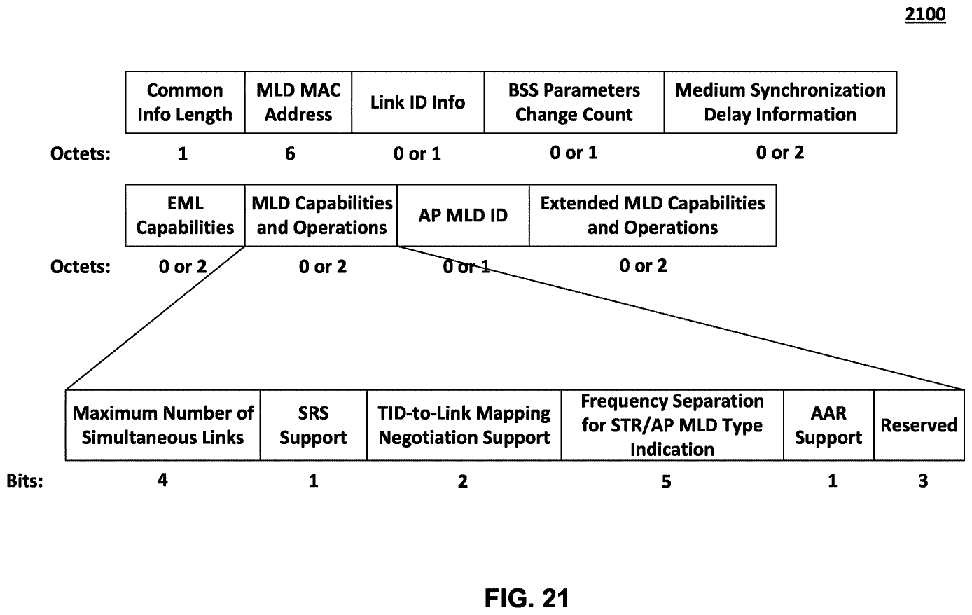

FIG. 21 illustrates an example common info field 2100 of a basic multi-link element according to an embodiment. The basic multi-link element may be transmitted by a STA to another STA to inform the other STA of its capabilities. As shown in FIG. 21, common info field 2100 may include a common info length subfield, a MLD MAC address subfield, a link ID info subfield, a BSS parameters change count subfield, a medium synchronization delay information subfield, an EML capabilities subfield, an MLD capabilities and operations subfield, an AP MLD ID subfield and an extended MLD capabilities and operations subfield.

In an embodiment, a reserved bit of the MLD capabilities and operations subfield may be used to signal an operation mode for the transmission of data comprising low latency traffic protected by an RTS/CTS exchange (e.g., Option-1 or Option-2 as described in FIG. 15 above).

FIG. 22 illustrates an example MU-RTS trigger frame 2200 according to an embodiment. MU-RTS trigger frame 2200 may be an embodiment of MU-RTS trigger frame 1823, 1824, 1921, 1922, 2021, and/or 2022 described above.

As shown in FIG. 22, example MU-RTS trigger frame 2200 may include a frame control subfield, a duration subfield, a receiver address (RA) subfield, a transmitter address (TA) subfield, a common info subfield, a padding subfield, an FCS subfield, and a user info list subfield.

In an embodiment, the user info list subfield may indicate one or more other links than a link over which MU-RTS trigger frame 2200 is being transmitted. The indication of the one or more other links in MU-RTS trigger frame 2200 indicates to a receiving STA that other MU-RTS trigger frames transmitted via the one or more other links request transmission of same data as MU-RTS trigger frame 2200. In an example, the indication of the one or more other links (e.g., 2.4 GHz band, 5 GHz band, 6 GHz band, etc.) may be transmitted in one or more of reserved bits of the user info list subfield.

In an example, the user info list subfield may further comprise an indication of a CTS reply option for use by the receiving STA. Accordingly, the CTS reply option may comprise the receiving STA responding to only one of multiple received MU-RTS trigger frames. Alternatively, the CTS reply option may also comprise the second STA responding to each of the multiple received MU-RTS trigger frames. In an example, the CTS reply option may be transmitted in the reserved bits of the user info list subfield.

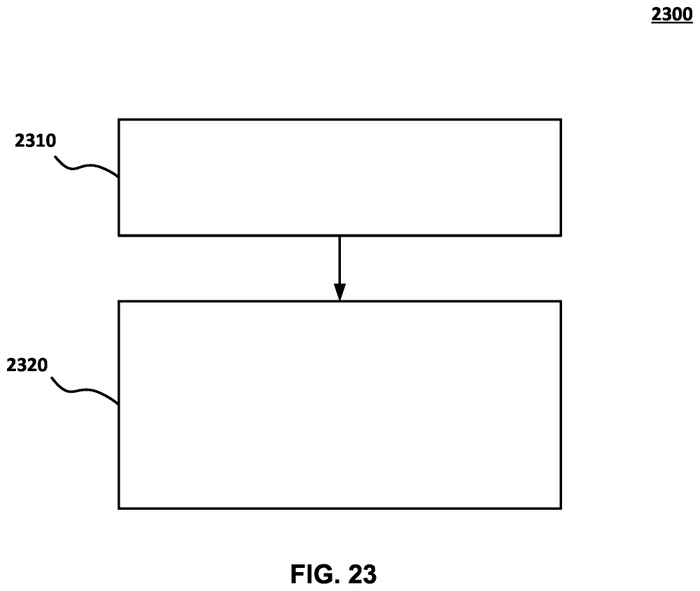

FIG. 23 illustrates an example process 2300 according to an embodiment. Example process 2300 is provided for the purpose of illustration only and is not limiting. Example process 2300 may be performed by a first STA, such as STA 1610, for example. The first STA may have a multi-link capability (i.e., comprising a multi-link device (MLD)). The first STA may be an AP STA or a non-AP STA. The first STA may be a transmitting STA that has data for transmission to a second STA. The second STA may also comprise an MLD. The first STA and the second STA may communicate over at least a first link and a second link.

As shown in FIG. 23, process 2300 may include, in step 2310, transmitting, by the first STA to the second STA, via the first link, a first RTS frame requesting transmission of first data, via the first link, to the second STA. In an embodiment, the first STA and the second STA may each comprise an AP MLD or a non-AP MLD capable of communicating over multiple links. In an embodiment, the first data may comprise low latency traffic.

In step 2320, process 2300 may include transmitting, by the first STA to the second STA, via the second link, a second RTS frame requesting transmission of the first data, via the second link, to the second STA, based on the first STA not receiving a first CTS frame from the second STA within a time period from transmission of the first RTS frame and based on the first data comprising low latency traffic.

In an embodiment, the time period may be less than a CTS timeout interval (and in accordance with Equation (1) described above). In another embodiment, the time period may be greater than or equal to a CTS timeout interval (and in accordance with Equation (1) described above).

In an embodiment, process 2300 may further comprise receiving, by the first STA from the second STA, via the second link, a second CTS frame in response to the second RTS frame. In an embodiment, process 2300 may further comprise transmitting, by the first STA to the second STA, the first data, via the second link.

In an embodiment, process 2300 may further comprise transmitting, by the first STA to the second STA, via the first link, a third RTS frame requesting transmission of the first data, via the first link, to the second STA. In an embodiment, the first STA transmits the third RTS frame when the first STA does not receive the first CTS frame from the second STA within the time period from transmission of the first RTS frame and when the first data comprises low latency traffic. In an embodiment, the third RTS frame may overlap with the second RTS frame.

In an embodiment, process 2300 may further comprise receiving by the first STA from the second STA, via the first link, a third CTS frame in response to the third RTS frame.

In another embodiment, the second and third RTS frames may comprise MU-RTS trigger frames. In an embodiment, process 2300 may further comprise receiving by the first STA from the second STA, via the second link, a second CTS frame in response to the second MU-RTS trigger frame. In an embodiment, process 2300 may further comprise transmitting, by the first STA to the second STA, the first data, via the second link.

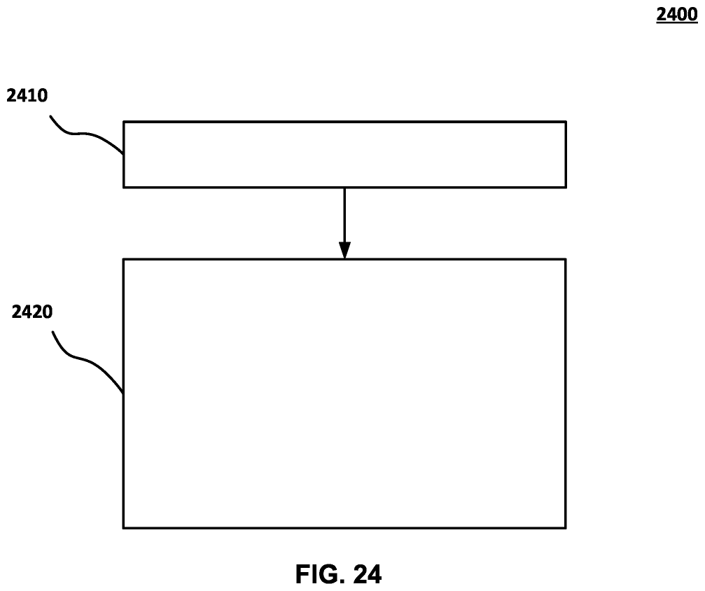

FIG. 24 illustrates another example process 2400 according to an embodiment. Example process 2400 is provided for the purpose of illustration only and is not limiting. Example process 2400 may be performed by a first STA, such as STA 1610, for example. The first STA may have a multi-link capability (i.e., comprising a multi-link device (MLD)). The first STA may be an AP STA or a non-AP STA. The first STA may be a transmitting STA that has data for transmission to a second STA. The second STA may also comprise an MLD. The first STA and the second STA may communicate over at least a first link and a second link.

As shown in FIG. 24, process 2400 may include, in step 2410, receiving, by a first STA, data for transmission to a second STA.

In step 2420, process 2400 may include, based on the data comprising low latency traffic, transmitting by the first STA to the second STA a first MU-RTS trigger frame, via a first link, requesting transmission of the data, via the first link, to the second STA, and a second MU-RTS trigger frame, via a second link, requesting transmission of the data, via the second link, to the second STA. In an embodiment, the first MU-RTS trigger frame may comprise an indication of the second link. In an embodiment, the indication of the second link in the first MU-RTS trigger frame may indicate to the second STA that the second MU-RTS trigger frame transmitted via the second link requests transmission of same data as the first MU-RTS trigger frame transmitted via the first link.

In a similar way, in an embodiment, the second MU-RTS trigger frame may comprise an indication of the first link. In an embodiment, the indication of the first link in the second MU-RTS trigger frame may indicate to the second STA that the first MU-RTS trigger frame transmitted via the first link requests transmission of same data as the second MU-RTS trigger frame transmitted via the second link.

In another embodiment, the first MU-RTS trigger frame or the second MU-RTS trigger frame may comprise an indication of a CTS reply option for use by the second STA. In an embodiment, the CTS reply option may comprise the second STA responding to one of the first MU-RTS trigger frame or the second MU-RTS trigger frame. In another embodiment, the CTS reply option may comprise the second STA responding to the first MU-RTS trigger frame and second MU-RTS trigger frame.

In an embodiment, process 2400 may further comprise receiving, by the first STA from the second STA, a first CTS frame, via the second link, in response to the second MU-RTS trigger frame. In an embodiment, process 2400 may further comprise transmitting, by the first STA to the second STA, via the second link, a data frame comprising the data.

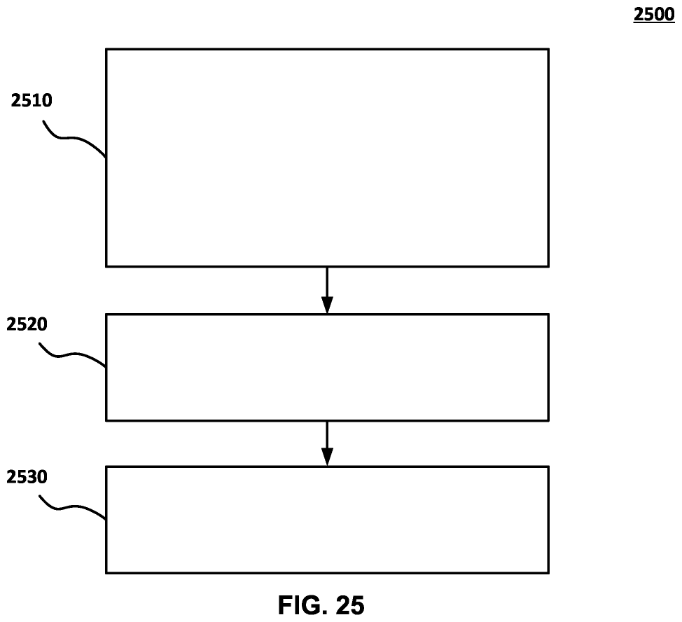

FIG. 25 illustrates another example process 2500 according to an embodiment. Example process 2500 is provided for the purpose of illustration only and is not limiting. Example process 2500 may be performed by a first STA, such as STA 1611, for example. Example process 1500 may be performed by a first STA having a multi-link capability (i.e., comprising a multi-link device (MLD)). The first STA may be an AP STA or a non-AP STA. The first STA may be a receiving STA that receives a data transmission from a second STA. The second STA may also comprise an MLD. The first STA and the second STA may communicate over at least a first link and a second link.

As shown in FIG. 25, process 2500 may include, in step 2510, receiving, by the first STA from the second STA a first MU-RTS trigger frame, via the first link, requesting transmission of data, via the first link, to the first STA, and a second MU-RTS trigger frame, via the second link, requesting transmission of the data, via the second link, to the first STA. In an embodiment, the first MU-RTS trigger frame may comprise an indication of the second link. In an embodiment, the indication of the second link in the first MU-RTS trigger frame may indicate to the second STA that the second MU-RTS trigger frame transmitted via the second link requests transmission of same data as the first MU-RTS trigger frame transmitted via the first link.

In a similar way, in an embodiment, the second MU-RTS trigger frame may comprise an indication of the first link. In an embodiment, the indication of the first link in the second MU-RTS trigger frame may indicate to the second STA that the first MU-RTS trigger frame transmitted via the first link requests transmission of same data as the second MU-RTS trigger frame transmitted via the second link.

In another embodiment, the first MU-RTS trigger frame or the second MU-RTS trigger frame may comprise an indication of a CTS reply option for use by the second STA. In an embodiment, the CTS reply option may comprise the second STA responding to one of the first MU-RTS trigger frame or the second MU-RTS trigger frame. In another embodiment, the CTS reply option may comprise the second STA responding to the first MU-RTS trigger frame and second MU-RTS trigger frame.

In step 2520, process 2500 may include, based on the second MU-RTS trigger frame comprising an indication of the first link, discarding the first MU-RTS trigger frame. In an embodiment, discarding the first MU-RTS trigger frame may comprise not transmitting a second CTS frame, via the first link, in response to the first MU-RTS trigger frame.

In step 2530, process 2500 may include transmitting, by the first STA to the second STA, a first CTS frame, via the second link, in response to the second MU-RTS trigger frame. In an embodiment, process 2500 may further comprise receiving, by the first STA from the second STA, via the second link, a data frame comprising the data. 1. A method, comprising:
transmitting, by a first wireless device to a second wireless device, via a first link, a first request frame requesting transmission of first data, via the first link, to the second wireless device; and
based on the first wireless device not receiving a first response frame from the second wireless device within a time period from transmission of the first request frame and the first data comprising low latency traffic, transmitting, by the first wireless device to the second wireless device, via a second link, a second request frame requesting transmission of the first data, via the second link, to the second wireless device.

There is a method, comprising: transmitting, by a first wireless device to a second wireless device, via a first link, a first request frame requesting transmission of first data, via the first link, to the second wireless device, and based on the first wireless device not receiving a first response frame from the second wireless device within a time period from transmission of the first request frame and the first data comprising low latency traffic, transmitting, by the first wireless device to the second wireless device, via a second link, a second request frame requesting transmission of the first data, via the second link, to the second wireless device.

In the method, there may be receiving, by the first wireless device from the second wireless device, via the second link, a second response frame in response to the second request frame; and transmitting, by the first wireless device to the second wireless device, the first data, via the second link.

In the method, there may be receiving, by the first wireless device from the second wireless device, via the second link, a second response frame in response to the second request frame and transmitting, by the second wireless device to the first wireless device, the first data, via the second link.

In the method, the time period may be less than a response timeout interval.

In the method, there may be comprising transmitting, by the first wireless device to the second wireless device, via the first link, a third request frame requesting transmission of the first data, via the first link, to the second wireless device.

In the method, there third request frame may overlap with the second request frame.

In the method, the time period may be greater than or equal to a response timeout interval.

In the method, the second and third request frames may comprise MU-RTS trigger frames.

In the method, there may be receiving by the first wireless device from the second wireless device, via the second link, a second response frame in response to the second request frame.

In the method, there may be receiving by the first wireless device from the second wireless device, via the first link, a third response frame in response to the third request frame.

The method may comprising receiving, by a first wireless device, data for transmission to a second wireless device, based on the data comprising low latency traffic, transmitting by the first wireless device to the second wireless device, a first multi-user request-to-send (MU-RTS) trigger frame, via a first link, requesting transmission of the data, via the first link, to the second wireless device, and a second MU-RTS trigger frame, via a second link, requesting transmission of the data, via the second link, to the second wireless device.

In the method, there may be receiving, by the first wireless device from the second wireless device, a first response frame, via the second link, in response to the second MU-RTS trigger frame.

The method may comprising receiving, by a first wireless device (wireless device) from a second wireless device a first multi-user request-to-send (MU-RTS) trigger frame, via a first link, requesting transmission of data, via the first link, to the first wireless device, and a second MU-RTS trigger frame, via a second link, requesting transmission of the data, via the second link, to the first wireless device; and based on the second MU-RTS trigger frame comprising an indication of the first link, discarding the first MU-RTS trigger frame; and transmitting, by the first wireless device to the second wireless device, a first response frame, via the second link, in response to the second MU-RTS trigger frame.

In the method, discarding the first MU-RTS trigger frame may comprise not transmitting a second response frame, via the first link, in response to the first MU-RTS trigger frame.

In the method, there may be transmitting, by the first wireless device to the second wireless device, via the second link, a data frame comprising the data.

In the method, the first MU-RTS trigger frame may comprise an indication of the second link.

In the method, the indication of the second link in the first MU-RTS trigger frame may indicate to the second wireless device that the second MU-RTS trigger frame transmitted via the second link requests transmission of same data as the first MU-RTS trigger frame transmitted via the first link.

In the method, the second MU-RTS trigger frame may comprises an indication of the first link.

In the method, the indication of the first link in the second MU-RTS trigger frame may indicate to the second wireless device that the first MU-RTS trigger frame transmitted via the first link requests transmission of same data as the second MU-RTS trigger frame transmitted via the second link.

In the method, the first MU-RTS trigger frame or the second MU-RTS trigger frame may comprise an indication of a CTS reply option for use by the second wireless device.

In the method, the CTS reply option may comprises the second wireless device responding to one of the first MU-RTS trigger frame or the second MU-RTS trigger frame.

In the method, the CTS reply option may comprise the second wireless device responding to the first MU-RTS trigger frame and second MU-RTS trigger frame.

In the method, the request frame may be a request-to-send (RTS) frame and the response frame may be a clear-to-send (CTS) frame.

There is a device, when acting as a first wireless device (wireless device), arranged to perform operations comprising transmitting, to a second wireless device, via a first link, a first request frame requesting transmission of first data, via the first link, to the second wireless device; and based on not receiving a first response frame from the second wireless device within a time period from transmission of the first request frame and the first data comprising low latency traffic, transmitting to the second wireless device, via a second link, a second request frame requesting transmission of the first data, via the second link, to the second wireless device.

There is a device, when acting as a first wireless device, arranged to perform operations comprising transmitting to a second wireless device, via a first link, a first request frame requesting transmission of first data, via the first link, to the second wireless device; and based on not receiving a first response frame from the second wireless device within a time period from transmission of the first request frame and the first data comprising low latency traffic, transmitting to the second wireless device, via a second link, a second request frame requesting transmission of the first data, via the second link, to the second wireless device.

There is a device, when acting as a first wireless device, arranged to perform operations comprising receiving data for transmission to a second wireless device, based on the data comprising low latency traffic, transmitting to the second wireless device a first multi-user request-to-send (MU-RTS) trigger frame, via a first link, requesting transmission of the data, via the first link, to the second wireless device, and a second MU-RTS trigger frame, via a second link, requesting transmission of the data, via the second link, to the second wireless device.

There is a device, when acting as a first wireless device, arranged to perform operations comprising receiving from a second wireless device a first multi-user request-to-send (MU-RTS) trigger frame, via a first link, requesting transmission of data, via the first link, to the device, and a second MU-RTS trigger frame, via a second link, requesting transmission of the data, via the second link, to the device; and based on the second MU-RTS trigger frame comprising an indication of the first link, discarding the first MU-RTS trigger frame; and transmitting to the second wireless device, a first response frame, via the second link, in response to the second MU-RTS trigger frame.

The wireless device may be a station (STA) according to IEEE 802.11.

In the device, the request frame may be a request-to-send (RTS) frame and the response frame may be clear-to-send (CTS) frame.

There is a wireless network comprising a plurality of devices as described in the foregoing.

There is a computer program product, stored on a computer-readable medium and arranged, when run a computing device, to perform the method described in the foregoing.

1. A method, comprising:
transmitting, by a first wireless device to a second wireless device, via a first link, a first request frame requesting transmission of first data, via the first link, to the second wireless device; and
based on the first wireless device not receiving a first response frame from the second wireless device within a time period from transmission of the first request frame and the first data comprising low latency traffic, transmitting, by the first wireless device to the second wireless device, via a second link, a second request frame requesting transmission of the first data, via the second link, to the second wireless device.

2. The method of claim 1 comprising receiving, by the first wireless device from the second wireless device, via the second link, a second response frame in response to the second request frame; and transmitting, by the first wireless device to the second wireless device, the first data, via the second link.

3. (canceled)

4. (canceled)

5. The method of claim 1, wherein the time period is less than a response timeout interval.

6. The method of claim 1, further comprising transmitting, by the first wireless device to the second wireless device, via the first link, a third request frame requesting transmission of the first data, via the first link, to the second wireless device.

7. The method of claim 6, wherein the third request frame overlaps with the second request frame.

8. The method of claim 1, wherein the time period is greater than or equal to a response timeout interval.

9. The method of claim 1, wherein the second and third request frames comprise MU-RTS trigger frames.

10. The method of claim 1, further comprising receiving by the first wireless device from the second wireless device, via the second link, a second response frame in response to the second request frame.

11. The method of claim 10, further comprising receiving by the first wireless device from the second wireless device, via the first link, a third response frame in response to the third request frame.

12. A method comprising:
receiving, by a first wireless device, data for transmission to a second wireless device;
based on the data comprising low latency traffic, transmitting by the first wireless device to the second wireless device:
a first multi-user request-to-send (MU-RTS) trigger frame, via a first link, requesting transmission of the data, via the first link, to the second wireless device, and;
a second MU-RTS trigger frame, via a second link, requesting transmission of the data, via the second link, to the second wireless device.

13. The method of claim 12, further comprising receiving, by the first wireless device from the second wireless device, a first response frame, via the second link, in response to the second MU-RTS trigger frame.

14. A method comprising:
receiving, by a first wireless device (wireless device) from a second wireless device:
a first multi-user request-to-send (MU-RTS) trigger frame, via a first link, requesting transmission of data, via the first link, to the first wireless device, and;
a second MU-RTS trigger frame, via a second link, requesting transmission of the data, via the second link, to the first wireless device; and
based on the second MU-RTS trigger frame comprising an indication of the first link, discarding the first MU-RTS trigger frame; and
transmitting, by the first wireless device to the second wireless device, a first response frame, via the second link, in response to the second MU-RTS trigger frame.

15. The method of claim 14, wherein discarding the first MU-RTS trigger frame comprises not transmitting a second response frame, via the first link, in response to the first MU-RTS trigger frame.

16. The method of claim 14, further comprising transmitting, by the first wireless device to the second wireless device, via the second link, a data frame comprising the data.

17. The method of claim 14, wherein the first MU-RTS trigger frame comprises an indication of the second link.

18. The method of claim 17, wherein the indication of the second link in the first MU-RTS trigger frame indicates to the second wireless device that the second MU-RTS trigger frame transmitted via the second link requests transmission of same data as the first MU-RTS trigger frame transmitted via the first link.

19. The method of claim 14, wherein the second MU-RTS trigger frame comprises an indication of the first link.

20. The method of claim 19, wherein the indication of the first link in the second MU-RTS trigger frame indicates to the second wireless device that the first MU-RTS trigger frame transmitted via the first link requests transmission of same data as the second MU-RTS trigger frame transmitted via the second link.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)
